(19) United States
(12) Patent Application Publication
(10) Pub. No.: US 2025/0358517 A1
(43) Pub. Date: Nov. 20, 2025

(54) IMAGING APPARATUS

(71) Applicant: Panasonic Intellectual Property Management Co., Ltd., Osaka (JP)

(72) Inventors: Michio KISHIBA, Osaka (JP); Mikio SAKURAI, Osaka (JP)

(73) Assignee: Panasonic Intellectual Property Management Co., Ltd., Osaka (JP)

(21) Appl. No.: 19/208,679

(22) Filed: May 15, 2025

(30) Foreign Application Priority Data
May 17, 2024 (JP) 2024-081155
Jan. 15, 2025 (JP) 2025-005442

(51) Int. Cl. H04N 23/68; G06T 5/80

(52) U.S. Cl. CPC H04N 23/687; G06T 5/80

(57) ABSTRACT

An imaging apparatus includes: an image sensor configured to capture the subject image to generate image data, the image sensor having an imaging area in which a subject image is formed through an optical system; a sensor configured to detect a shake amount of the imaging apparatus; and an image processor configured to perform image stabilization by adjusting an output area according to the shake amount detected by the sensor, the output area being output as an image in the image data. In the image processor, distortion correction responsive to distortion aberration of the optical system is performed on an image area indicated by the image data. The image processor performs the image stabilization without a correction area in a corrected image area by the distortion correction, the correction area being provided within a range corresponding to the imaging area to crop the image of the output area.

### TECHNICAL FIELD

The present disclosure relates to an imaging apparatus having an image stabilizing function.

### BACKGROUND ART

JP 2010-273245 A discloses an imaging apparatus that aims to perform shake correction by efficiently using an image sensing area of an image device. This imaging apparatus extracts an image of an extraction area rotated or moved in accordance with a shake correction amount (correction angle) from an image obtained by performing correction of distortion aberration generated by an imaging optical system for a picked up image. As described above, in the imaging apparatus of JP 2010-273245 A, using an image area drawn outward from the center of the image by the correction of distortion aberration, a shake in a direction of rotation about the optical axis of the imaging optical system, or a pan direction and a tilt direction is corrected by rotating or moving the extraction area.

### SUMMARY

The present disclosure provides an imaging apparatus capable of efficiently correcting image distortion due to camera shake while suppressing reduction in an angle of view.

An imaging apparatus according to one aspect of the present disclosure includes: an image sensor configured to capture a subject image to generate image data, the image sensor having an imaging area in which the subject image is formed through an optical system; a sensor configured to detect a shake amount of the imaging apparatus; and an image processor configured to perform image stabilization by adjusting an output area according to the shake amount detected by the sensor, the output area being output as an image in the image data. In the image processor, distortion correction responsive to distortion aberration of the optical system is performed on an image area indicated by the image data. The image processor performs the image stabilization without a correction area in a corrected image area by the distortion correction, the correction area being provided within a range corresponding to the imaging area to crop the image of the output area.

An imaging apparatus according to another aspect of the present disclosure includes: an image sensor configured to capture a subject image to generate image data, the image sensor having an imaging area in which the subject image is formed through an optical system; a sensor configured to detect a shake amount of the imaging apparatus; an image processor configured to perform image stabilization by adjusting an output area according to the shake amount detected by the sensor, the output area being output as an image in the image data; and a controller configured to control the image stabilization performed by the image processor. In the image processor, distortion correction responsive to distortion aberration of the optical system is performed on an image area indicated by the image data. The controller changes a ratio between first image stabilization and second image stabilization according to a focal length of the optical system, the first and second image stabilizations each being performed by the image processor in a corrected image area by the distortion correction. The first image stabilization corrects perspective distortion of the image in the corrected image area by the distortion correction. The second image stabilization moves the output area for the image in the image area.

According to the imaging apparatus of the present disclosure, it is possible to efficiently correct image distortion due to camera shake while suppressing reduction in an angle of view.

### BRIEF DESCRIPTION OF DRAWINGS

FIG. 1 is a perspective view of a digital camera according to a first embodiment of the present disclosure;

FIG. 2 is a block diagram showing a configuration of the digital camera according to the first embodiment;

FIG. 3 is a block diagram showing a configuration of an IBIS processor in the digital camera according to the first embodiment;

FIG. 4 is a diagram for illustration of correction modes by an EIS function of the digital camera according to the first embodiment;

FIG. 5 is a diagram for illustration of an EIS function with cropping in the digital camera;

FIGS. 6A and 6B are diagrams for illustration of correction against distortion aberration of an optical system of the digital camera;

FIGS. 7A to 7D are diagrams for illustration of camera shake due to tilt of the digital camera;

FIG. 8 is a diagram for illustration of a cropless EIS function in the digital camera of the first embodiment;

FIG. 9 is a flowchart illustrating an overall operation related to image stabilization in the digital camera according to the first embodiment;

FIGS. 10A and 10B are diagrams for illustration of calculation processing of a distortion correction parameter in the digital camera;

FIG. 11 is a flowchart illustrating calculation processing of a perspective correction parameter in the digital camera;

FIG. 12 is a diagram for illustration of calculation processing of a surplus area in the calculation processing of the perspective correction parameter;

FIG. 13 is a flowchart illustrating an operation of the digital camera according to a modified example of the first embodiment;

FIG. 14 is a diagram for illustration of an operation of the digital camera according to a second embodiment; and

FIG. 15 is a flowchart illustrating the operation of the digital camera according to the second embodiment.

### DETAILED DESCRIPTION

Hereinafter, embodiments of the present disclosure will be described with reference to the drawings as appropriate. However, in the detailed description, unnecessary parts in descriptions of the conventional technique and the substantially same configuration may be omitted. This is to simplify the description. In addition, the following description and the accompanying drawings are disclosed so that those skilled in the art can fully understand the present disclosure, and not intended to limit the subject matter of the claims.

### First Embodiment

In a first embodiment, an example of a digital camera having an image stabilizing function will be described as an example of an imaging apparatus.

### 1. Configuration

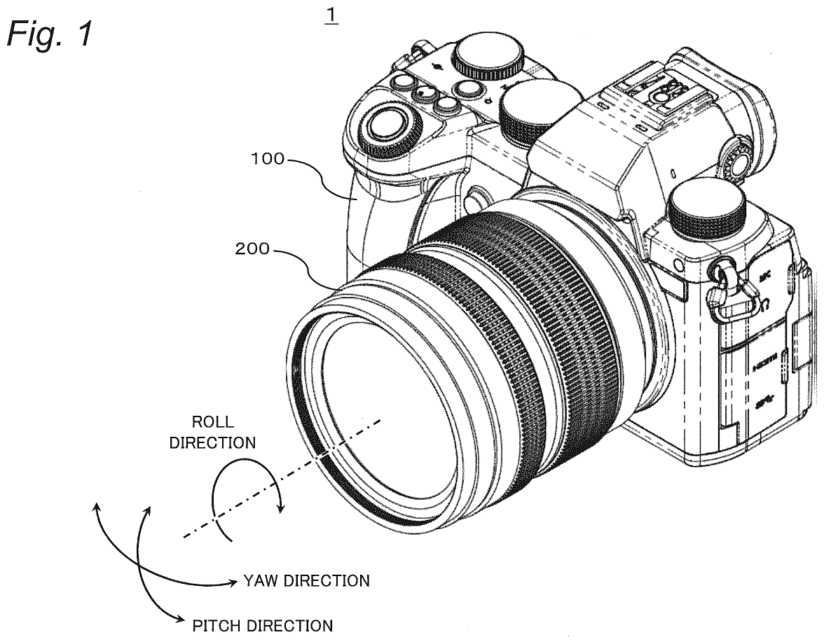

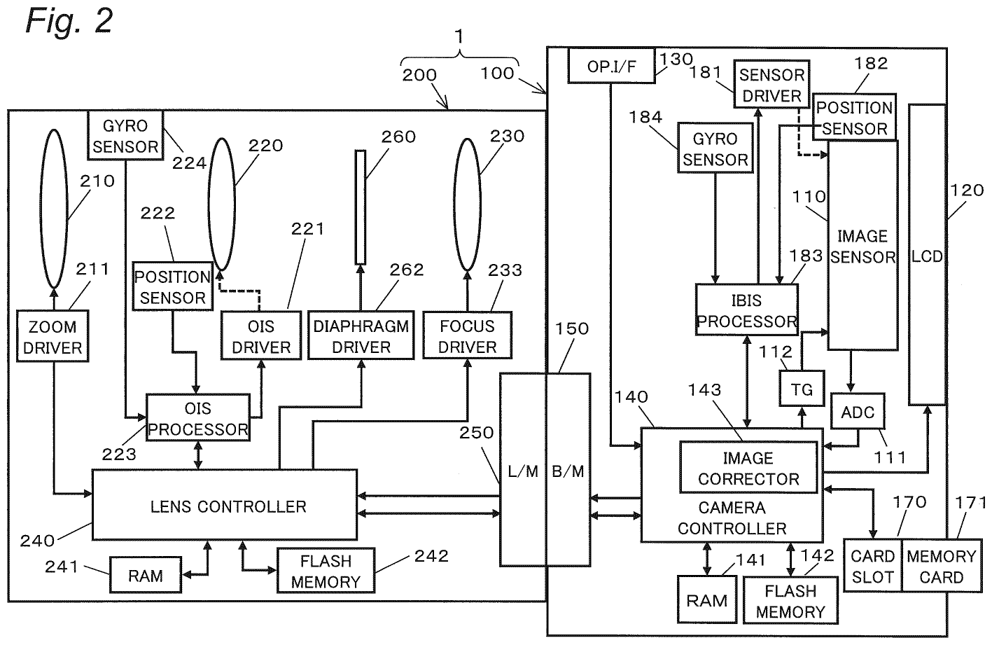

FIG. 1 is a perspective view of a digital camera 1 according to the first embodiment. FIG. 2 is a block diagram showing a configuration of the digital camera 1. The digital camera 1 includes a camera body 100 and an interchangeable lens 200 detachable from the camera body 100.

In the following description, a function of correcting shake by moving an image sensor in the camera body 100 is referred to as an “in-body image stabilizer (IBIS) function”. Further, a function of correcting shake by moving a correction lens in the interchangeable lens 200 is referred to as an “optical image stabilizer (OIS) function”. Moreover, a function of correcting shake by adjusting an area of an image to be output in image data generated by the image sensor is referred to as an “electronic image stabilizer (EIS) function”. In the following description, the IBIS function and the OIS function may be collectively referred to as an optical image stabilizing function, and the EIS function may be referred to as an electronic image stabilizing function.

Further, in the following description, rotation directions corresponding to a horizontal direction and a vertical direction of the image sensor in the digital camera 1 are referred to as a yaw direction and a pitch direction, respectively, and a rotation direction around a rotation axis along an optical axis of the digital camera 1 is referred to as a roll direction (see FIG. 1).

### 1-1. Camera Body

The camera body 100 (an example of the imaging apparatus) includes an image sensor 110, a liquid crystal monitor 120, an operation interface 130, a camera controller 140, a body mount 150, and a card slot 170. Furthermore, the camera body 100 includes an image corrector 143 that implements an EIS function as a functional configuration of the camera controller 140, for example.

The camera controller 140 controls the entire operation of the digital camera 1 by controlling components such as the image sensor 110 according to an instruction from the release button. The camera controller 140 transmits a vertical synchronization signal to a timing generator 112. In parallel with this, the camera controller 140 generates an exposure synchronization signal. The camera controller 140 periodically transmits the generated exposure synchronization signal to a lens controller 240 via the body mount 150 and a lens mount 250. The camera controller 140 uses a RAM 141 as a work memory during control operation and image processing operation.

The image sensor 110 is an example of the image sensor that captures a subject image incident through the interchangeable lens 200 to generate image data. The image sensor 110 is, for example, a CCD, a CMOS image sensor, or an NMOS image sensor. The generated image data is digitized by an AD converter 111. The digitized image data is subjected to predetermined image processing by the camera controller 140. Examples of the predetermined image processing include gamma correction processing, white balance correction processing, scratch correction processing, YC conversion processing, electronic zoom processing, and JPEG compression processing.

The image sensor 110 is operated at a timing controlled by the timing generator 112. The image sensor generates a still image or a moving image, or a through image for recording. The through image is mainly a moving image, and is displayed on the liquid crystal monitor 120 for a user to determine a composition for capturing a still image.

The liquid crystal monitor 120 displays various information such as an image such as a through image and a menu screen. The liquid crystal monitor 120 is an example of a display in the present embodiment. Instead of the liquid crystal monitor, another type of display device, for example, an organic EL display device may be used.

The operation interface 130 includes various operation members such as a release button for instructing start of image capturing, a mode dial for setting an image capturing mode, and a power switch. The operation interface 130 also includes a touch panel layered with the liquid crystal monitor 120.

The card slot 170 can be inserted with a memory card 171, and the memory card 171 is controlled based on control from the camera controller 140. The digital camera 1 can store image data in the memory card 171, and read the image data from the memory card 171.

The body mount 150 can be mechanically and electrically connected to the lens mount 250 of the interchangeable lens 200. The body mount 150 can transmit and receive data to and from the interchangeable lens 200 via the lens mount 250. The body mount 150 transmits the exposure synchronization signal received from the camera controller 140 to the lens controller 240 via the lens mount 250. In addition, other control signals received from the camera controller 140 are transmitted to the lens controller 240 via the lens mount 250. Further, the body mount 150 transmits a signal received from the lens controller 240 via the lens mount 250 to the camera controller 140.

The camera body 100 further includes, as a configuration that realizes the IBIS function, a gyro sensor 184 (shake detector) that detects vibration of the camera body 100, and an IBIS processor 183 that controls shake correction processing based on a result of the detection by the gyro sensor 184. The camera body 100 further includes a sensor driver 181 that moves the image sensor 110, and a position sensor 182 that detects a position of the image sensor 110.

The sensor driver 181 can be realized by, for example, a magnet and a flat coil. The sensor driver 181 may include another motor, an actuator, or the like. The position sensor 182 is a sensor that detects the position of the image sensor 110 in a plane perpendicular to an optical axis of an optical system. The position sensor 182 can be realized by, for example, a magnet and a Hall element.

The IBIS processor 183 controls the sensor driver 181 to shift the image sensor 110 in the plane perpendicular to the optical axis to offset shake of the camera body 100 based on the signal from the gyro sensor 184 and the signal from the position sensor 182. A range in which the image sensor 110 can be driven by the sensor driver 181 is mechanically limited. The range in which the image sensor 110 can be driven by the sensor driver 181 in the IBIS function is referred to as an “element drive range”.

### 1-2. Interchangeable Lens

The interchangeable lens 200 includes an optical system, the lens controller 240, and the lens mount 250. The optical system includes a zoom lens 210, an optical image stabilizer (OIS) lens 220, a focus lens 230, and a diaphragm 260.

The zoom lens 210 is a lens for changing magnification of a subject image formed by the optical system. The zoom lens 210 includes one or more lenses. The zoom lens 210 is driven by a zoom driver 211. The zoom driver 211 includes a zoom ring that can be operated by the user. Alternatively, the zoom driver 211 may include a zoom lever, and an actuator or a motor. The zoom driver 211 moves the zoom lens 210 along a direction of the optical axis of the optical system according to the operation by the user.

The focus lens 230 is a lens for changing a focus state of a subject image formed on the image sensor 110 in the optical system. The focus lens 230 includes one or more lenses. The focus lens 230 is driven by a focus driver 233.

The focus driver 233 includes an actuator or a motor, and moves the focus lens 230 along the optical axis of the optical system based on the control of the lens controller 240. The focus driver 233 can be realized by a DC motor, a stepping motor, a servo motor, an ultrasonic motor, or the like.

The OIS lens 220 is a lens for correcting shake of a subject image formed by the optical system of the interchangeable lens 200 in the OIS function. The OIS lens 220 moves in a direction by which the shake of the digital camera 1 is canceled, and thus reduces the shake of the subject image on the image sensor 110. The OIS lens 220 includes one or more lenses. The OIS lens 220 is driven by an OIS driver 221.

Under the control of an OIS processor 223, the OIS driver 221 shifts the OIS lens 220 in a plane perpendicular to the optical axis of the optical system. A range in which the OIS lens 220 can be driven by the OIS driver 221 is mechanically limited. The range in which the OIS lens 220 can be driven by the OIS driver 221 is referred to as a “lens drive range”. The OIS driver 221 can be realized by, for example, a magnet and a flat coil. A position sensor 222 is a sensor that detects the position of the OIS lens 220 in the plane perpendicular to an optical axis of an optical system. The position sensor 222 can be realized by, for example, a magnet and a Hall element. The OIS processor 223 controls the OIS driver 221 based on an output of the position sensor 222 and an output of a gyro sensor 224 (shake detector).

The diaphragm 260 adjusts an amount of light incident on the image sensor 110. The diaphragm 260 is driven by a diaphragm driver 262 so that a size of an opening of the diaphragm 260 is controlled. The diaphragm driver 262 includes a motor or an actuator.

The gyro sensor 184 or 224 detects shake (vibration) in the yaw direction, the pitch direction, and the roll direction based on an angular change of the digital camera 1 per unit time, that is, an angular velocity. The gyro sensor 184 or 224 outputs an angular velocity signal indicating the detected amount of vibration (angular velocity) to the IBIS processor 183 or the OIS processor 223. The angular velocity signal output by the gyro sensor 184 or 224 may include a wide range of frequency components due to camera shake, a mechanical noise, or the like. Instead of the gyro sensor, another sensor capable of detecting shake of the digital camera 1 can be used. In addition, the gyro sensor 224 of the interchangeable lens 200 may not detect shake in the roll direction.

The camera controller 140 and the lens controller 240 may be configured by a hard-wired electronic circuit, or may be configured by a microcomputer using a program, or the like. For example, the camera controller 140 and the lens controller 240 can be realized by various processors such as a CPU, an MPU, a GPU, a DSU, an FPGA, or an ASIC.

### 1-3. Configuration of Image Stabilizing Function

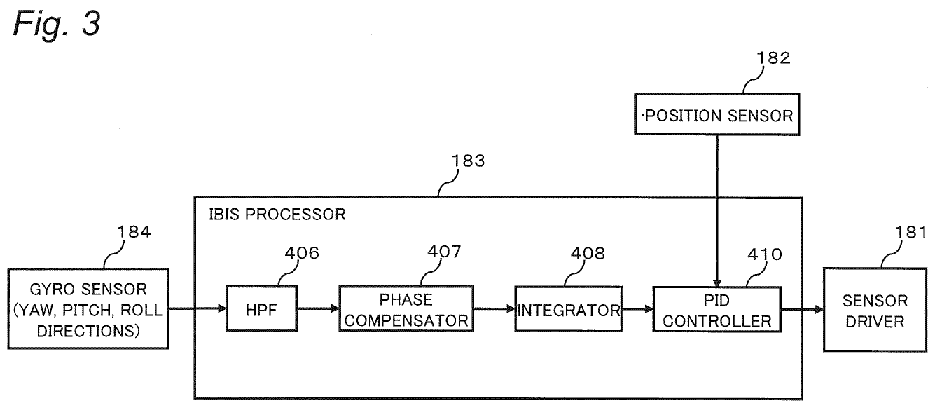

Configurations for realizing various image stabilizing functions of the digital camera 1 in the present embodiment will be described with reference to FIGS. 3 to 5.

### 1-3-1. IBIS Processor

A configuration of the IBIS processor 183 in the camera body 100 will be described with reference to FIG. 3. FIG. 3 is a block diagram showing a configuration of the IBIS processor 183 in the digital camera 1 according to the present embodiment. The IBIS processor 183 includes a high-pass filter (HPF) 406, a phase compensator 407, an integrator 408, and a PID controller 410. For example, the IBIS processor 183 receives a signal from the gyro sensor 184 at a predetermined time interval (e.g., 4 kHz).

In order to block the drift component, the HPF 406 blocks a predetermined low frequency component included in the signal received from the gyro sensor 184, for example.

The phase compensator 407 corrects a phase delay due to the sensor driver 181 or the like to a signal received from the HPF 406.

The integrator 408 integrates a signal received from the phase compensator 407 and indicating the angular velocity of shake (vibration), and generates a signal indicating the angle of the shake (vibration) (hereinafter referred to as a “shake detection signal”). The shake detection signal from the integrator 408 is input to the PID controller 410. Here, the IBIS processor 183 may use or add a filter configuration other than the above configuration, such as a notch filter for noise processing.

The PID controller 410 generates a drive signal for shifting the image sensor 110 based on an output from the position sensor 182 and an output from the integrator 408, and outputs the drive signal to the sensor driver 181. The sensor driver 181 drives the image sensor 110 based on the drive signal. Specifically, the sensor driver 181 translates the image sensor 110 in the horizontal direction or the vertical direction of an imaging plane within a range in which the sensor can move, or moves the image sensor 110 rotationally around the optical axis direction as a rotation axis.

The IBIS processor 183 is configured to be capable of data communication with the camera controller 140. For example, the IBIS processor 183 starts/ends the image stabilizing operation according to a control signal from the camera controller 140. In addition, the IBIS processor 183 transmits various types of information regarding the image stabilizing operation to the camera controller 140.

For example, the IBIS processor 183 may calculate the shake correction amounts in the horizontal direction and the vertical direction of the imaging plane as a displacement amount of the image sensor 110 by the sensor driver 181, based on angles of the shake in the yaw direction and the pitch direction indicated by the generated shake detection signal. The IBIS processor 183 may acquire a focal length according to a zoom state from the interchangeable lens 200 via the camera controller 140, or may calculate the shake correction amount by converting the correction angle for offsetting an angle of the shake into the displacement amount of the image sensor 110 using the acquired focal length or the like.

In the configuration same as the IBIS processor 183 as described above, the OIS processor 223 can be configured to drive the OIS driver 221 instead of the sensor driver 181, for example. Furthermore, the OIS processor 223 operates, for example, using a detection result of the gyro sensor 224 in the interchangeable lens 200 instead of the gyro sensor 184 in the camera body 100.

### 1-3-2. Correction Mode by EIS Function

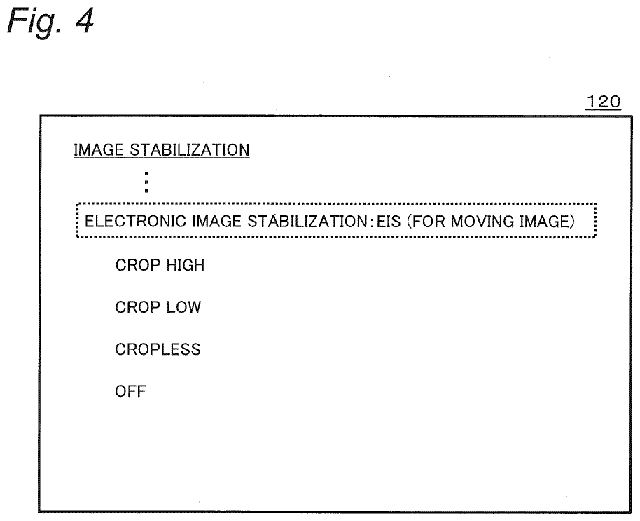

The digital camera 1 of the present embodiment has a plurality of correction modes as operation modes to correct the shake by the image stabilizing function. FIG. 4 is a diagram for illustration of the correction modes by the EIS function of the digital camera 1 of the present embodiment.

In the digital camera 1 of the present embodiment, a correction mode used for the image stabilization by the EIS function can be selected by a user's operation. FIG. 4 illustrates a menu screen for setting a correction mode to be used in capturing a moving image in the digital camera 1. In the example of FIG. 4, the liquid crystal monitor 120 displays “crop high”, “crop low”, “cropless”, and “OFF” as menu items corresponding to the respective correction modes. When the menu item “OFF” is selected, the EIS function is disabled.

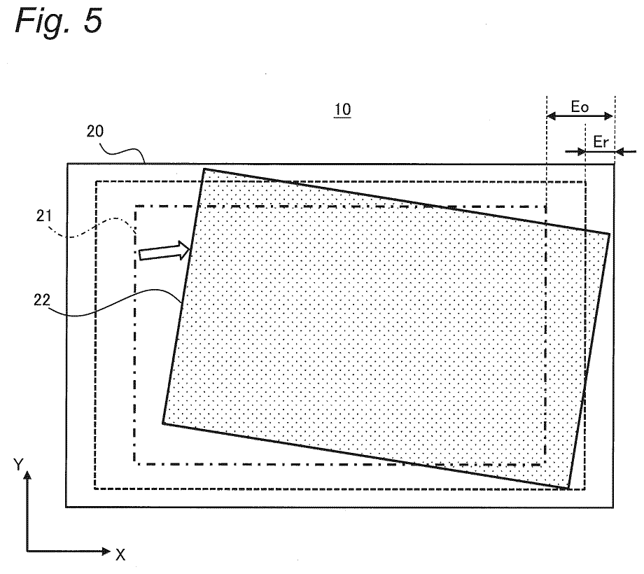

In the correction modes of “crop high” and “crop low”, the image corrector 143 corrects the camera shake by changing, according to the camera shake, an area from which an image is cropped in an imaging area of the image sensor 110. The EIS function with cropping will be described with reference to FIG. 5. FIG. 5 is a diagram for illustration of the EIS function with cropping in the digital camera 1.

As illustrated in FIG. 5, for example, the image corrector 143 performs processing to crop an image in a narrowed area by the preset cropping amount Eo from an entire image in the image data 10 generated by the image sensor 110. For example, the cropping amount Eo is calculated by the number of pixels according to a predetermined cropping rate for each in the horizontal direction X and the vertical direction Y of the image data 10, and an image in which the number of pixels is reduced by the cropping amount Eo calculated in each in the directions X and Y is cropped. For example, various types of image processing performed by the camera controller 140 for recording an imaging result are performed on such image data after cropping. For example, electronic zoom processing may be performed so that a cropped image has the same size as the image before cropping.

For example, the cropping amount Eo of a predetermined amount stored in advance in the flash memory 142 or the like for each of the correction modes with cropping is set in the image corrector 143, according to the user's operation selecting the menu item of “crop high” or “crop low”. In the “crop high” correction mode, the cropping amount Eo larger than that in the “crop low” correction mode is set. For example, in the “crop high” correction mode, the cropping amount Eo is set such that the number of pixels included in the image after cropping is reduced by 20% to 30% from the number of pixels in the image before cropping. In the “crop low” correction mode, the cropping amount Eo by which the number of pixels decreases by about 8% before and after cropping is set.

Based on the shake detection signal input from the integrator 408 of the IBIS processor 183, the image corrector 143 calculates the shake correction amount as an adjustment amount of a cropping position. The image corrector 143 realizes the EIS function in the “crop high” or “crop low” correction mode by adjusting a position where an image is cropped by the calculated shake correction amount. For example, with a center position of the entire image in the image data 10 as a reference, a base area 21, in which a cropped image is located when the shake correction amount by the EIS function with cropping is zero, is set. The base area 21 is arranged, for example, along the horizontal direction X and the vertical direction Y of the image data 10. For example, an area other than the base area 21 in the image data 10 is an example of the correction area in the present embodiment.

The image corrector 143 translates an image area 22 cropped from the base area 21 in the horizontal direction X according to the shake correction amount in the horizontal direction of the image sensor 110 acquired from the IBIS processor 183, for example. Similarly, the image corrector 143 translates the image area 22 in the vertical direction Y according to the shake correction amount in the vertical direction of the image sensor 110. In addition, the image corrector 143 rotates a direction of the image area 22 from a direction of the base area 21 on an XY plane according to the shake correction amount in the roll direction.

The position adjustment of the image area 22 as described above, that is, the EIS function with cropping can be executed within a range of the cropping amount Eo. Specifically, the translation of the image area 22 is performed within a range of an amount obtained by removing an amount for the roll as a margin Er from the cropping amount Eo. Further, the rotation of the image area 22 is performed within a range of a rotation angle that falls within the margin Er for the roll in the cropping amount Eo. The margin Er for roll is determined by the camera controller 140 according to the lens state of the interchangeable lens 200, for example. For example, in a case where the interchangeable lens 200 is wide-angle, a displacement amount of the image area 22 for correcting the shake amounts in the yaw direction and the pitch direction becomes small, and thus, the margin Er for roll is determined to be larger as the focal length is shorter.

On the other hand, in the digital camera 1 of the present embodiment, when the “cropless” correction mode is selected on the menu screen or the like in FIG. 4, a cropless EIS function is performed. The cropless EIS function is a EIS function in which the above-described cropping amount Eo is not provided within a range corresponding to the imaging area in the image data 10. In this case, as the corrected image, an image having an angle of view similar to an unreduced angle of view (or the number of pixels in the range) is obtained, the unreduced angle of view being obtained in a case where the EIS function is “OFF” (i.e., invalidated). As described above, with the cropless EIS function, in the image data 10, it is possible to perform the image stabilization while suppressing a decrease in the number of pixels due to cropping of an image, and while maintaining the angle of view in imaging. The image corrector 143 realizes the cropless EIS function according to lens characteristics of the interchangeable lens 200 as described later, for example.

### 2. Operation

The operation of the digital camera 1 configured as described above will be described below.

### 2-1. Correction of Distortion Aberration

In the digital camera 1 of the present embodiment, for example, the image corrector 143 corrects distortion aberration due to the optical system of the interchangeable lens 200 in the captured image in addition to the operation of image stabilization by the EIS function.

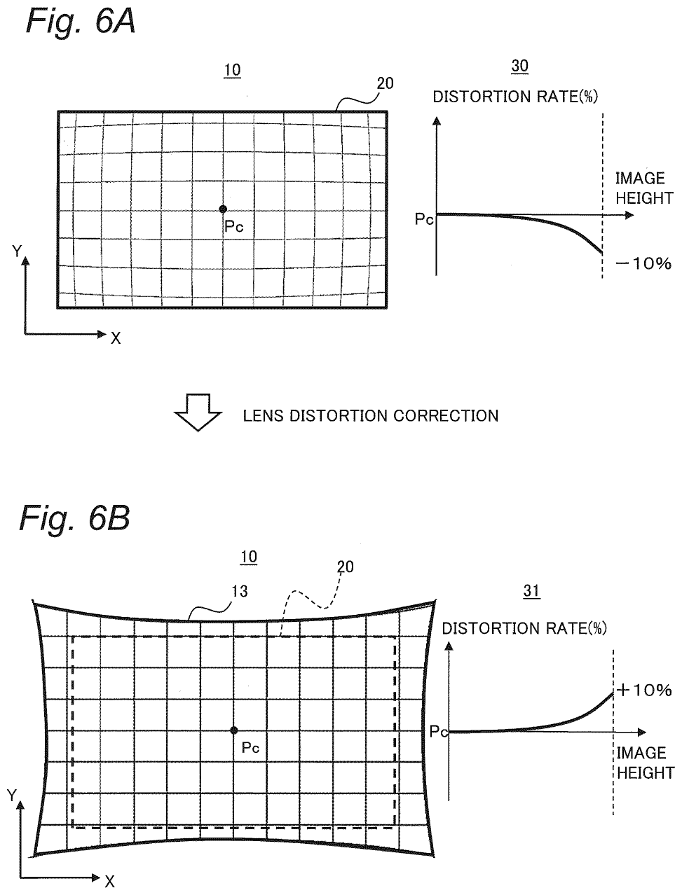

FIGS. 6A and 6B are diagrams for illustration of correction against distortion aberration of the optical system of digital camera 1. For example, as illustrated in FIG. 6A, the distortion aberration caused by lens characteristics or the like of the interchangeable lens 200 may cause image distortion in the image data 10 generated by the image sensor 110. In the image data 10, a range of the entire image corresponding to the imaging area of the image sensor 110 constitutes an image forming area 20 in which an image is formed according to the number of output pixels in recording an imaging result before applying various corrections of the image, for example.

FIG. 6A illustrates an example in which the optical system of the interchangeable lens 200 has a negative distortion aberration. In a captured image indicated by the image data 10 of FIG. 6A, so-called barrel distortion occurs. The barrel distortion is a lens distortion in which a peripheral part contracts, or shrinks with respect to a center position Pc of the entire image due to the negative distortion aberration.

FIG. 6A illustrates distortion characteristic data 30 indicating characteristics of the distortion aberration in interchangeable lens 200. The distortion characteristic data 30 associates an image height with respect to the center position Pc with a distortion rate. For example, the distortion rate indicates a change rate of the image height at which a subject image is formed on the imaging plane of image sensor 110 from a case where no distortion aberration occurs. The sign of the distortion rate is positive when an image forming position of the subject image on the imaging plane changes, from the case where no distortion aberration occurs, changes in a direction in which the image height increases. The sign of the distortion rate is negative when the image forming position changes in a direction in which the image height decreases. For example, in a wide-angle lens having a relatively wide angle of view as a lens characteristic, the barrel distortion, which is distortion aberration indicating a negative distortion rate, is likely to occur.

The characteristic of the distortion aberration also changes depending on the focal length according to the zoom state of the interchangeable lens 200, a focus position according to the focus state, and the like. For example, the barrel distortion is likely to occur in a wide-angle setting where the focal length is relatively short.

For example, as illustrated in FIG. 6B, the image corrector 143 corrects the distortion aberration by, in the image data 10 of FIG. 6A, deforming the image so that the peripheral part is expanded outward with respect to the center position Pc from the image forming area 20. The image corrector 143 performs such distortion correction (also referred to as lens distortion correction) based on distortion correction data 31 illustrated in FIG. 6B, for example. The distortion correction data 31 associates the image height relative to the center position Pc with a correction factor. For example, the correction factor indicates a rate of deformation of the image by the distortion correction from a state before the distortion correction.

According to the distortion correction as described above, an enlarged image area 13 is obtained, the enlarged image area being enlarged from the image forming area 20 corresponding to the rectangular imaging area in the image data 10. For example, in a case where the shake correction amount by the EIS function is zero or the EIS function is disabled, in the image data 10, the image corrector 143 crops an image having the same size as that of the range corresponding to the imaging area, with the center position Pc as the center, from the enlarged image area 13, and outputs the cropped image. The image corrector 143 in the digital camera 1 of the present embodiment realizes the cropless EIS function in the image data 10 by using the enlarged image area 13 obtained by such distortion correction and enlarged from the image forming area 20 before the correction.

In the above description, the case in which the barrel distortion is corrected as the distortion correction is described. In pincushion distortion indicating the positive distortion rate, the captured image becomes an image in which the peripheral part extends outward with respect to the center position Pc. The digital camera 1 performs the distortion correction on such pincushion distortion so that the peripheral part of the image is contracted. In such a case where the enlarged image area 13 cannot be obtained by the distortion correction, the digital camera 1 of the present embodiment does not execute the cropless EIS function, for example. On the other hand, for mustache distortion in which the barrel distortion and the pincushion distortion appear in combination, for example, the cropless EIS function may be applied when the enlarged image area 13 is obtained by the distortion correction similarly to the correction of the barrel distortion.

### 2-2. Correction of Perspective Distortion

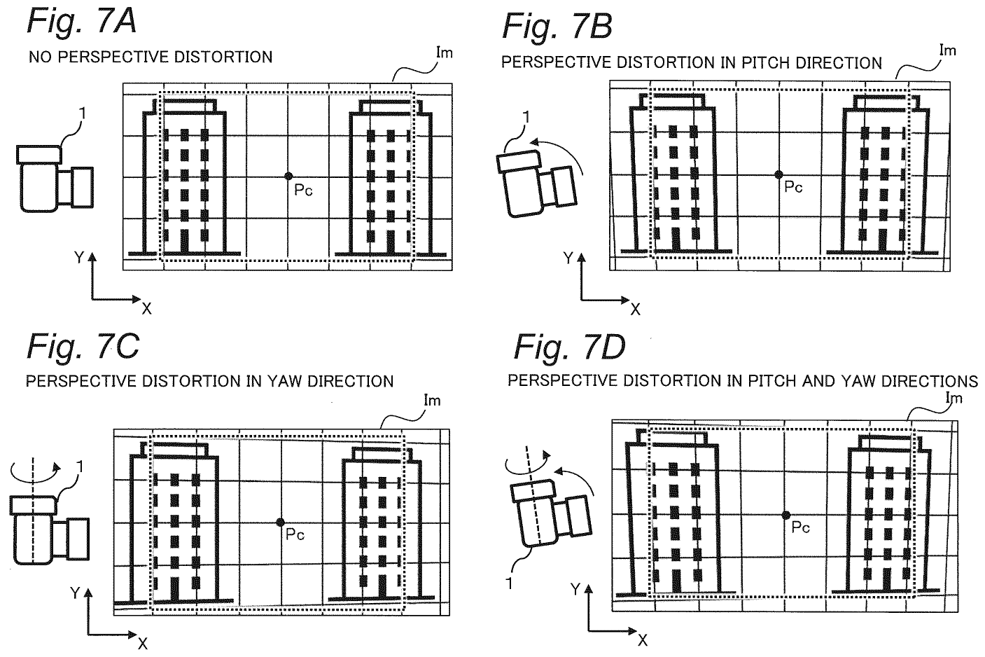

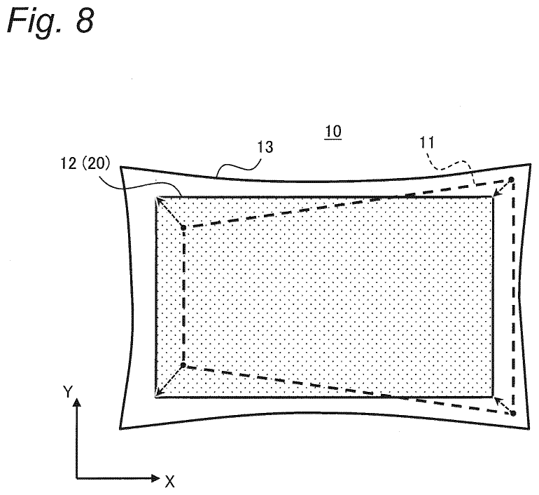

In addition to the distortion aberration as described above, for example, in a situation where camera shake is relatively large such that the user (e.g., a photographer) captures a moving image or the like while walking, distortion may occur in a peripheral part or the like of the captured image also due to the camera shake as a tilt in which a posture of the digital camera 1 changes. Correction of such perspective distortion will be described with reference to FIGS. 7A to 7D and 8.

FIGS. 7A to 7D are diagrams for illustration of camera shake due to the tilt of the digital camera 1. Each of FIGS. 7A to 7D illustrates a posture of the digital camera 1 and a captured image Im in which the same subject is captured by the digital camera 1 in the posture.

FIG. 7A shows an example in which no perspective distortion occurs. FIG. 7B illustrates an example in which the posture of the digital camera 1 changed in the pitch direction from the state of FIG. 7A. For example, as illustrated in FIG. 7B, in the captured image Im in a case where the perspective distortion in the pitch direction occurs, trapezoidal distortion occurs such that the subject image expands in the horizontal direction X on one side of the vertical direction Y and contracts on the other side.

FIG. 7C illustrates an example in which the posture of the digital camera 1 changed from the state of FIG. 7A in the yaw direction instead of the pitch direction in FIG. 7B. For example, as illustrated in FIG. 7C, in the captured image Im in a case where the perspective distortion in the yaw direction occurs, trapezoidal distortion occurs such that the subject image expands in the vertical direction Y on one side of the horizontal direction X and contracts on the other side. FIG. 7D illustrates an example in which the posture of the digital camera 1 changed from the state of FIG. 7A in both the pitch direction and the yaw direction. In this case, distortion occurs such that the captured image Im expands and contracts in a trapezoidal shape in both of the horizontal direction X and the vertical direction Y It is known that such trapezoidal distortion due to various types of camera shake by the tilt remarkably appears in the captured image Im particularly in wide-angle shooting with a relatively wide imaging range.

For example, in a central part of the captured image Im, reduction of the shake in the yaw, pitch, and roll directions can be expected by performing, with reference to the center position Pc, translation and rotation of the image sensor 110 by the IBIS function and/or translation and rotation of the image area 22 cropped by the EIS function. On the other hand, in the captured image Im, even when the correction by the translation and the rotation as described above is performed, it is concerned that the trapezoidal distortion, as the perspective distortion due to the camera shake by the tilt, remains and becomes significant particularly in the peripheral part distant from the center position Pc.

Therefore, in the image data 10, the digital camera 1 corrects the trapezoidal distortion due to such a tilt shake, by deformation processing of the image to restore the trapezoidal distortion. In such trapezoid correction of the image, it is required to use an image area wider than a corrected area for the deformation processing to perform projective transformation of coordinates on the image responsive to the trapezoid distortion, for example. Therefore, the digital camera 1 of the present embodiment uses the enlarged image area 13 obtained by the distortion correction as illustrated in FIG. 6B for the trapezoid correction by the cropless EIS function to correct the trapezoid distortion caused as the perspective distortion.

FIG. 8 is a diagram for illustration of the cropless EIS function in the digital camera 1 of the present embodiment. In the digital camera 1 of the present embodiment, the image corrector 143 sets a reference area 11 to be deformed by the trapezoid correction from the enlarged image area 13 obtained by the distortion correction in the image data 10. Then, the image corrector 143 outputs the image of an output area 12 as the corrected area deformed from the reference area 11. The output area 12 is an area recorded in the memory card 171 or displayed on the liquid crystal monitor 120 in the image data 10, for example, and has the number of pixels corresponding to a resolution or the like of an image recorded as the imaging result.

As described above, in the image data 10 in which the distortion aberration such as the barrel distortion occurs, the digital camera 1 of the present embodiment corrects the perspective distortion using the enlarged image area 13 obtained by the distortion correction. As described above, by using the enlarged image area 13 wider than the image forming area 20 (see, FIG. 6) corresponding to the imaging area of the image sensor 110 for correcting the trapezoidal distortion caused as the perspective distortion, for example, an image of the output area 12 having the same number of pixels as that of the image forming area 20 can be output. Accordingly, a perspective correction to correct such image distortion can be realized while suppressing the reduction in the angle of view due to the cropping of the image.

For example, in the EIS function with cropping in which the image area 22 is cropped from the base area 21 according to the cropping amount Eo in the image forming area 20 as illustrated in FIG. 5, the number of pixels of the image area 22 to be output decreases from the number of pixels of the image forming area 20. For this reason, for example, when the correction is performed by the EIS function with cropping, the image of the image area 22 cropped to a smaller angle of view than before the correction is output. On the other hand, in the cropless EIS function, both the perspective correction and maintaining the angle of view can be achieved as described above.

The example in which the image of the output area 12 having the same number of pixels as the image forming area 20 is output in the cropless EIS function is described above, but the number of pixels may be substantially the same between the output area 12 and the image forming area 20. For example, even in a case where the number of pixels decreases according to various types of image processing by the camera controller 140, the cropless EIS function may be executed such that a reduction rate of the number of pixels is 1/10 of or less than the reduction rate in the correction mode of “crop low”. According to such a cropless correction mode, the image stabilization can be performed without substantially reducing the number of pixels after the correction from the number before the correction.

### 2-3. Overall Operation

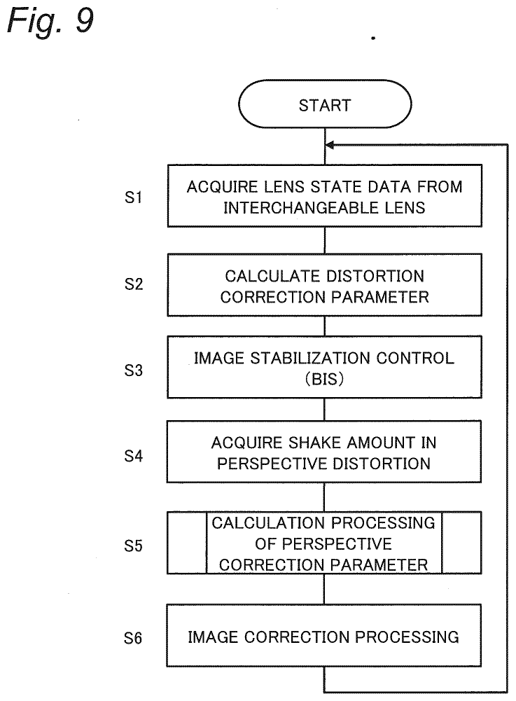

The digital camera 1 of the present embodiment performs the image stabilizing operation by the IBIS function in combination with the distortion correction against the distortion aberration and the perspective correction by the image corrector 143 as described above. An overall operation regarding the image stabilization in the digital camera 1 of the present embodiment will be described with reference to FIG. 9. FIG. 9 is a flowchart illustrating an overall operation related to the image stabilization in the digital camera 1 according to the first embodiment.

The processing shown in the flowchart of FIG. 9 is started, for example, in a state where the interchangeable lens 200 is mounted on the camera body 100 and the cropless correction mode is selected by a user operation using the menu screen in FIG. 4. Each processing in this flowchart is executed in parallel with an operation such as moving image capturing by the camera controller 140, for example. For example, the camera controller 140 repeatedly executes the processing shown in this flowchart at a predetermined period. The predetermined period is, for example, a frame period (e.g., from 1/30 seconds to 1/60 seconds).

The camera controller 140 performs data communication with the lens controller 240 of the interchangeable lens 200 via the body mount 150 and the lens mount 250, to acquire lens state data (S1). The lens controller 240 reads out the lens state data in response to a request from the camera controller 140 and transmits the lens state data to the camera body 100, for example.

For example, the lens state data includes a focal length according to a zoom state, and a focus position according to a focus state of the interchangeable lens 200, and is stored in the RAM 241, and the like of the interchangeable lens 200.

The camera controller 140 calculates a distortion correction parameter used for the distortion correction based on the lens state data and the like acquired in step S1 (S2). For example, the distortion correction parameter includes a distortion correction coefficient used for coordinate transformation for each pixel to deform an image by the distortion correction.

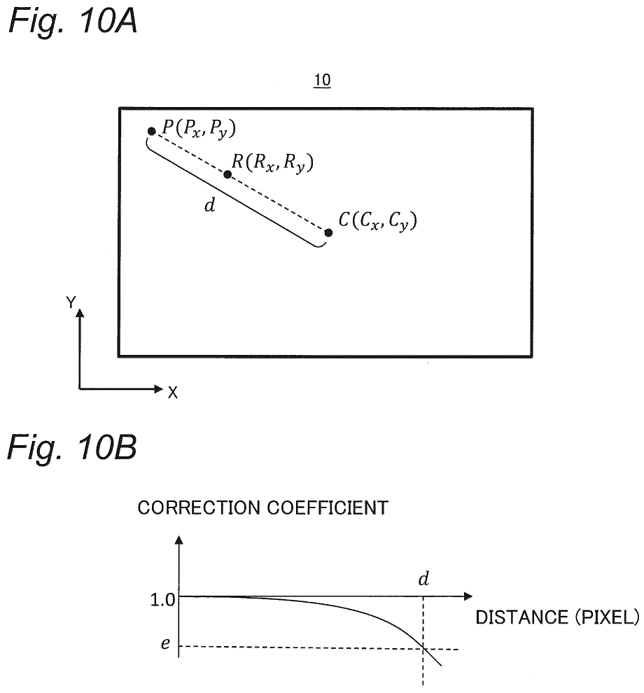

FIGS. 10A and 10B are diagrams for illustration of calculation processing of the distortion correction parameter (S2) in the digital camera 1. In the distortion correction as illustrated in FIG. 10A, in the image data 10, coordinates of a pixel R converted from coordinates of a pixel P according to the deformation of the image are calculated, based on a distance “d” from a distortion correction center C to each pixel P, the distortion correction center C corresponding to an intersection point between the optical axis and the imaging plane of the image sensor 110, for example.

In FIG. 10A, (Cx, Cy) indicates the coordinates of the distortion correction center C, (Px, Py) indicates the coordinates of the pixel P, and (Rx, Ry) indicates the coordinates of the pixel R. For example, in the image data 10, the pixel P is located in the image area output by the distortion correction, and the pixel R is located in the image forming area 20 referred to in the distortion correction (see FIG. 6).

In step S2, the camera controller 140 calculates, for each pixel P, a distortion correction coefficient “e” as illustrated in FIG. 10B, based on the distance “d” to the distortion correction center C and the distortion correction data 31 as illustrated in FIG. 6B, for example. For example, the center position Pc of the entire image in the image data 10 is used as the distortion correction center C. The distance “d” is calculated, for example, as a Euclidean distance, and indicates the number of pixels corresponding to the image height in the distortion correction data 31 of FIG. 6B.

For example, before the processing of this flowchart is executed, the distortion characteristic data 30 as illustrated in FIG. 6A may be acquired for each combination of the focal length and the focus position through data communication with the interchangeable lens 200, and stored in the RAM141 or the like. In step S2, the camera controller 140 may read the distortion characteristic data 30 according to the focal length and the focus position in the lens state data, and acquire the distortion correction data 31 based on the distortion characteristic data 30, as an inverse characteristic of the distortion aberration characteristic by interpolation processing or the like as needed.

The camera controller 140 sets, for example, various parameters in the IBIS processor 183 to control the image stabilizing operation executed by the IBIS processor 183 (see FIG. 3) in the digital camera 1 (S3). The camera controller 140 may calculate angular ranges correctable by the IBIS function in the pitch and yaw directions based on, for example, information indicating the element drive range in the IBIS function and the focal length of the interchangeable lens 200 in the lens state data, and set the calculated angular range in the IBIS processor 183. The information indicating the element drive range may be stored in advance in the flash memory 142 or the like. The camera controller 140 may acquire, from the IBIS processor 183, current shake correction amount for execution of step S3, as the shake correction amount according to the state in which the shake is corrected by the IBIS function, for example.

The IBIS processor 183 generates shake detection signals in the pitch direction, the yaw direction, and the roll direction in the integrator 408 based on the detection result by the gyro sensor 184 of the camera body 100. For example, according to the shake amounts indicated by the shake detection signals in the yaw direction and the pitch direction, the IBIS processor 183 calculates the shake correction amount in each direction as the displacement amount of the image sensor 110 in the horizontal direction and the vertical direction, respectively, based on the generated shake detection signal. Further, the IBIS processor 183 calculates the shake correction amount in the roll direction as the displacement amount of the image sensor 110 in the roll direction. The IBIS processor 183 may limit the calculated shake correction amounts within the correctable angular range set as described above, for example.

The IBIS processor 183 causes the sensor driver 181 to translate the image sensor 110 according to the calculated shake correction amounts in the horizontal direction and the vertical direction. According to the shake amount in the roll direction, the IBIS processor 183 causes the sensor driver 181 to move the image sensor 110 rotationally according to the calculated shake correction amount. The IBIS processor 183 performs the above-described image stabilizing operation as needed according to the detection result of the gyro sensor 184 in various parameters set by the camera controller 140, for example.

The camera controller 140 acquires, from the IBIS processor 183, the shake amount indicated by the shake detection signals in the yaw direction and the pitch direction as a tilt amount due to the shake of the camera body 100, for example (S4). For example, such a shake amount in the perspective distortion is acquired based on the shake detection signal at the time of exposure according to the exposure synchronization signal.

The camera controller 140 performs calculation processing of a perspective correction parameter used for the perspective correction based on the acquired shake amount in the perspective distortion and the like (S5). The perspective correction parameter includes, for example, a parameter of the projective transformation that deforms the image according to the shake amount in the perspective distortion. In step S5 of the present embodiment, in a case where the enlarged image area 13 by the distortion correction cannot be obtained, the camera controller 140 does not calculate the perspective correction parameter. This determination is made in accordance with the distortion correction parameter and the like calculated in step S2. Details of the calculation processing of the perspective correction parameter (S5) will be described later.

The camera controller 140 executes, as the image corrector 143, arithmetic processing to deform an image based on the distortion correction parameter calculated in step S2 and the perspective correction parameter calculated in step S5 (S6). In such image correction processing (S6), the image corrector 143 of the present embodiment applies the calculation processing for the distortion correction and the perspective correction collectively to the image data 10 on which the image stabilizing operation by the IBIS function has been performed in accordance with the image stabilization control (S3). Furthermore, in the image correction processing of the present embodiment, the coordinate transformation for each pixel that deforms the image is calculated to determine a corresponding pixel of the image forming area 20 before the distortion correction from each pixel of the output area 12 after the perspective correction.

In the perspective correction, the projective transformation is calculated according to the following equation (1) using the perspective correction parameter and the like calculated in step S5. The perspective correction parameter includes a rotation matrix R and a translational displacement amount “t” of the digital camera 1. In the equation (1), coordinates (xa, ya, za) indicate three-dimensional coordinates projected onto coordinates (xb, yb) on a two-dimensional image by the projective transformation, for example. The coordinates (xb, yb) indicate the coordinates in the output area 12 (see FIG. 8) after the perspective correction. Here, “f” represents the focal length of the interchangeable lens 200 in the lens state data.

$$\begin{matrix}[ Equation 1 ] & \\ [ \begin{matrix}xa \\ ya \\ za\end{matrix} ] = R [ \begin{matrix}xb \\ yb \\ f\end{matrix} ] + t & ( 1 )\end{matrix}$$

Furthermore, from the coordinates (xa, ya, za), the coordinates (x, y) corresponding to coordinates (Px, Py) of the pixel P in the distortion correction are calculated according to the following equation (2), for example.

$$\begin{matrix}[ Equation 2 ] & \\ x = f \cdot xa / za , y = f \cdot ya / za & ( 2 )\end{matrix}$$

In step S6, the image corrector 143 performs calculation by the equations (1) and (2) for the number of pixels in the output area 12, for example. For example, in a case where the perspective correction parameter is not calculated, the image corrector 143 performs only the operation of the distortion correction without performing the operations of the equations (1) and (2).

For example, in the distortion correction, the coordinates (Rx, Ry) of the pixel R in the image forming area 20 are calculated, according to the following equation (3) with the distortion correction coefficient “e” calculated in step S2 from the coordinates (Px, Py) of the pixel P in the reference area 11 for the perspective correction. The image corrector 143 performs the calculation for the number of pixels in the output area 12 in FIG. 8, for example.

$$\begin{matrix}[ Equation 3 ] & \\ Rx = e ( Px - Cx ) + Cx , Ry = e ( Py - Cy ) + Cy & ( 3 )\end{matrix}$$

According to the above processing, the distortion correction parameter is calculated according to the lens state data acquired from the interchangeable lens 200 (S1, S2). Furthermore, the image stabilizing operation by the IBIS function is executed according to the image stabilization control (S3) with the shake correction amount in the roll direction in addition to the shake correction amounts in the horizontal direction and the vertical direction of the image sensor 110. Then, the shake amounts in the perspective distortion in the yaw direction and the pitch direction are acquired (S4), and the calculation processing of the perspective correction parameter is performed according to the shake amounts in the perspective distortion or the like (S5). The image corrector 143 performs correction on the image data 10 from the image sensor 110 according to the respective calculated correction parameters (S6). Therefore, when the cropless correction mode is selected in the EIS function, the distortion correction and the perspective correction can be efficiently performed by the deformation of the image using the respective calculated correction parameters.

For example, in the present embodiment, the perspective correction or the like is performed by the image corrector 143 after the correction in the horizontal direction and the vertical direction of the image sensor 110 according to the shake amounts in the yaw direction and the pitch direction, and the correction for the shake amount in the roll direction are performed by the image stabilizing operation by the IBIS function (S6). Therefore, in the image corrector 143, it is possible to correct the distortion of the image due to the perspective distortion while suppressing the reduction in the angle of view, by performing only the perspective correction by the cropless EIS function as the image stabilization, in addition to the distortion correction.

In step S6 described above, the example in which the distortion correction and the perspective correction are applied to the image data 10 collectively is described, but the perspective correction may be performed on the image data 10 with the distortion correction being applied, for example. In this case, the distortion correction may be executed before the calculation processing of the perspective correction parameter (S5). For example, in step S6, calculation for the distortion correction may be performed similarly to the processing in step S21 described later. Furthermore, in the digital camera 1, the distortion correction function may be forcibly enabled when the cropless correction mode is selected.

### 2-4. Calculation Processing of Perspective Correction Parameter

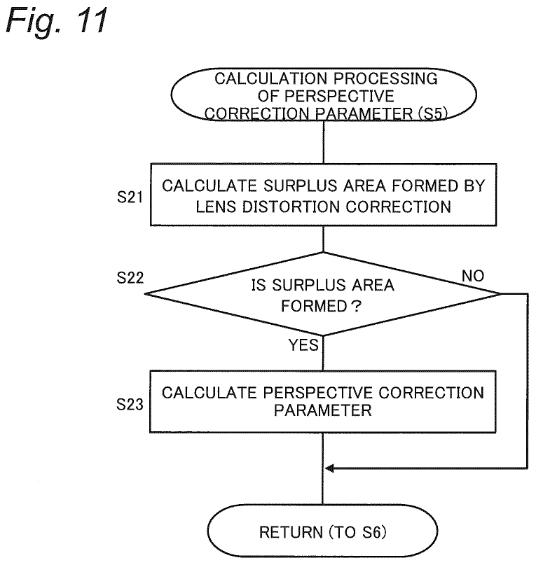

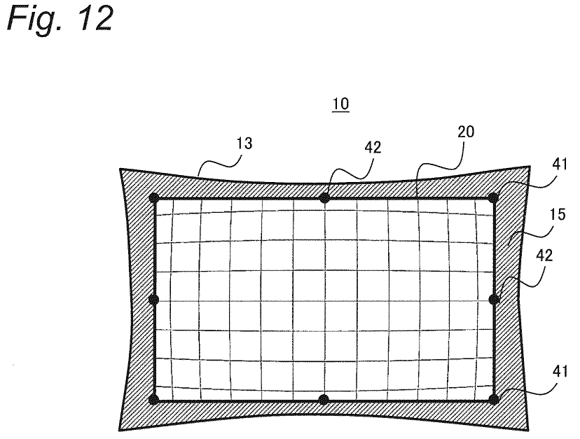

The calculation processing of the perspective correction parameter in step S5 of FIG. 9 will be described with reference to FIGS. 11 and 12.

FIG. 11 is a flowchart illustrating calculation processing (S5) of the perspective correction parameter in the digital camera 1. The processing illustrated in this flowchart is started in a state where the lens state data of the interchangeable lens 200 is acquired in step S1 of FIG. 9, the distortion correction parameter is calculated in step S2, and the shake amount in the perspective distortion is acquired in step S4, for example.

First, the camera controller 140 calculates, in the image data 10 from the image sensor 110, a surplus area generated by the distortion correction based on coordinates indicating the position of the image forming area 20 and the distortion correction parameter (S21). FIG. 12 is a diagram for illustration of the calculation processing of the surplus area (S21) in the calculation processing of the perspective correction parameter (S5). FIG. 12 illustrates a surplus area 15 generated by the distortion correction in the image data 10. In the image data 10, the surplus area 15 is an area that does not include the image forming area 20 in the enlarged image area 13 obtained by the distortion correction.

In the present embodiment, the camera controller 140 calculates the coordinates after the distortion correction for each of pixels of eight points including vertexes 41 and midpoints 42 of respective sides of the rectangular image forming area 20 as illustrated in FIG. 12, for example (S21). As described above, the coordinates of the area that can be the surplus area 15 are partially calculated. As a result, a calculation speed for calculating the surplus area 15 can be improved, and processing load on the camera controller 140 can be reduced.

In step S21, for example, in similar calculation to that of the equation (3) for the distortion correction in the image correction processing (S6), coordinate transformation is performed such that the coordinates of each pixel as a calculation target are input as (Px, Py) from the image forming area 20, and the coordinates in the surplus area 15 are output as (Rx, Ry). Contrary to the example of FIG. 10B, the distortion correction coefficient “e” in this case changes to increase according to the distance “d” from the distortion correction center C to each pixel as the calculation target, and “e>1” is satisfied in the peripheral portion of the image in the correction of the barrel distortion.

Next, the camera controller 140 compares the coordinates calculated in step S21 with the coordinates corresponding to the coordinates in the image forming area 20, and determines whether the surplus area 15 is formed outside the range of the image forming area 20 in the image data 10 (S22). For example, when all the calculated coordinates are out of the range of the image forming area 20, the camera controller 140 determines that the surplus area 15 is formed (YES in S22).

When the surplus area 15 is formed (YES in S22), the camera controller 140 calculates the perspective correction parameter (S23). The camera controller 140 calculates the rotation matrix R and the translational displacement amount t(tₓ, t_{y}, t_{z}) of the digital camera 1 for the projective transformation, according to the following equations (4) and (5), based on a focal length “f” in the lens state data of the interchangeable lens 200 and the shake amount in the perspective distortion acquired in step S4, for example. In the equations (4) and (5), “pitch” and “yaw” respectively represent the shake amount in the perspective distortion (e.g., angle) in the pitch direction and the yaw direction. For example, x_{c} and y_{c} in the equation (5) respectively indicate positions in the horizontal direction X and the vertical direction Y of an optical axis center corresponding to the intersection point of the optical axis of the optical system and the imaging plane of the image sensor 110 with reference to the center position Pc of the entire image in the image data 10. The camera controller 140 acquires x_{c} and y_{c} from the IBIS processor 183, for example. For example, x, and y, are calculated as values obtained by converting an output from the integrator 408 into a displacement amount on the imaging plane or calculated based on the output from the position sensor 182.

$$\begin{matrix}[ Equation 4 ] & \\ R = [ \begin{matrix}1 & 0 & 0 \\ 0 & cos ( pitch ) & - sin ( pitch ) \\ 0 & sin ( pitch ) & cos ( pitch )\end{matrix} ] [ \begin{matrix}cos ( yaw ) & 0 & sin ( yaw ) \\ 0 & 1 & 0 \\ - s in ( yaw ) & 0 & cos ( yaw )\end{matrix} ] & ( 4 )\end{matrix}$$

$$\begin{matrix}[ Equation 5 ] & \\ {t}_{x} = {x}_{c} - ( cos ( pitch ) {x}_{c} + sin ( yaw ) f ) & ( 5 )\end{matrix}$$

$${t}_{y} = {y}_{c} - ( sin ( pitch ) sin ( yaw ) {x}_{c} + cos ( pitch ) {y}_{c} - sin ( pitch ) cos ( yaw ) f )$$

$${t}_{z} = f - ( - cos ( pitch ) sin ( yaw ) {x}_{c} + sin ( pitch ) {y}_{c} + cos ( pitch ) cos ( yaw ) f )$$

After calculating the perspective correction parameter (S23), the camera controller 140 ends the processing of this flowchart, and proceeds to step S6 in FIG. 9.

When the surplus area 15 is not formed (NO in S22), the camera controller 140 does not calculate the perspective correction parameter (S23), and ends the processing of this flowchart.

According to the above processing, the calculation processing of the surplus area is performed based on the image forming area 20 in the image data 10 and the distortion correction parameter (S21), and when the surplus area 15 is formed by the distortion correction (YES in S22), the perspective correction parameter is calculated (S23). On the other hand, when no surplus area 15 is formed (NO in S22), the perspective correction parameter is not calculated. In this manner, when the surplus area 15 outside the range of the image forming area 20 is formed by the distortion correction, the perspective correction can be performed in addition to the distortion correction in the image correction processing (S6 of FIG. 9) using the calculated perspective correction parameter.

When the surplus area 15 is formed (YES in S22), the perspective correction can be performed by the cropless EIS function using the enlarged image area 13, which is obtained by the distortion correction and enlarged to an extent corresponding to the surplus area 15 from the image forming area 20. Accordingly, the perspective correction can be realized while suppressing the reduction in the angle of view.

In step S23, in calculation of the perspective correction parameter, an upper limit may be set for the shake correction amount by the perspective correction, for example. For example, the upper limit of the shake correction amount is set according to the size of the surplus area 15, and when the shake correction amount that cancels all of the shake amounts in the perspective distortion acquired in step S4 of FIG. 9 is larger than the upper limit, the shake correction amount may be limited to the upper limit. In addition, the pixels of the calculation target, for which the coordinates after the distortion correction from the image forming area 20 are calculated, in the calculation processing of the surplus area (S21) is not limited to the above-described eight points. For example, by performing the calculation for more than eight points, the upper limit of the shake correction amount can be set more accurately.

### 2-5. Modified Example

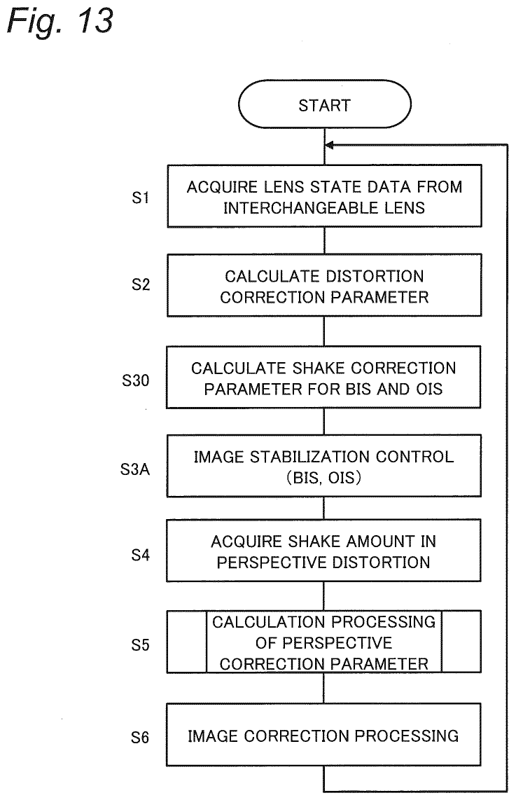

The first embodiment as above describes the example in which the image stabilizing operation by the IBIS function and the perspective correction by the image correction processing (S6) are performed. The image stabilizing operation may be performed by a cooperative operation by the IBIS function and the OIS function. Such a modified example of the first embodiment will be described with reference to FIG. 13.

FIG. 13 is a flowchart illustrating an operation of the digital camera 1 according to the modified example of the first embodiment. The digital camera 1 of the present modified example executes, in addition to the operation (S1 to S2, S4 to S6) similar to that in the digital camera 1 of the first embodiment, calculation processing of a shake correction parameter used for the image stabilizing operation by the IBIS function and the OIS function (S30). In the present modified example, the digital camera 1 controls the image stabilizing operation by the IBIS function and the OIS function instead of controlling the image stabilizing operation by the IBIS function in the first embodiment (S3 in FIG. 9) (S3A).

For example, the camera controller 140 calculates the shake correction parameter based on the lens state data of the interchangeable lens 200 acquired in step S1, the information indicating the element drive range in the IBIS function, information indicating the lens drive range in the OIS function, and the like (S30). The shake correction parameter includes, for example, a correction ratio to distribute a shake correction amount between the IBIS processor 183 and the OIS processor 223, and the like. The correction ratio is calculated for each of the horizontal direction and the vertical direction of the image sensor 110, and the roll direction. The shake correction parameter may include, for example, a frequency band corresponding to the distribution between the IBIS processor 183 and the OIS processor 223 with respect to the frequency component included in the angular velocity signal from the gyro sensor 184 and 224.

The camera controller 140 controls the image stabilizing operation by the IBIS function and the OIS function using the calculated shake correction parameter (S3A). For example, the camera controller 140 sets a gain indicating the distribution of the IBIS processor 183 in the calculated correction ratio in the IBIS processor 183. The IBIS processor 183 calculates the shake correction amount by multiplying the shake detection signal from the integrator 408 by the gain. The camera controller 140 may set a frequency band to be cut by the HPF 406 or the like of the IBIS processor 183. Furthermore, in the present modified example, the camera controller 140 may calculate x_{c} and y_{c} of the equation (5) based further on information acquired from the OIS processor 223 when calculating the perspective correction parameter (S5, S23).

Furthermore, the camera controller 140 transmits the calculated shake correction parameter to the interchangeable lens 200 via the body mount 150 and the lens mount 250. The camera controller 140 may set the shake correction parameter in the OIS processor 223 via the lens controller 240.

According to the above processing, the shake correction parameter is calculated (S3A, S30) so that the IBIS function and the OIS function are cooperatively controlled, and the image stabilizing operation by these functions is performed according to the shake correction parameter. Thus, the image stabilization using the shake correction amounts in the translation direction and the roll direction of the image sensor 110 other than the perspective correction can be performed by the optical image stabilizing function, for example, and the perspective correction can be performed by the cropless EIS function in the image correction processing (S6).

### 3. Summary

As described above, the digital camera 1 (an example of an imaging apparatus) according to the present embodiment includes: the image sensor 110 (an image sensor) configured to capture a subject image to generate image data, the image sensor 110 having the imaging area in which the subject image is formed through the optical system; the gyro sensor 184, 224 (a sensor) configured to detect the shake amount of the digital camera 1; and the image corrector 143 (an image processor) configured to perform image stabilization by adjusting an output area 12 according to the shake amount detected by the sensor, the output area 12 being output as an image in the image data. In the image corrector 143, distortion correction responsive to the distortion aberration of the optical system is performed on an image area indicated by the image data 10 (S2, S6). The image corrector 143 performs the image stabilization by the cropless EIS function as an example of the image stabilization without a correction area provided in a corrected image area by the distortion correction, the correction area being provided within the image forming area 20 (a range corresponding to the imaging area) to crop the image of the output area 12 (S5, S6) (see FIG. 8).

According to the above imaging apparatus, in the image area with the distortion correction being performed, the image stabilization by the cropless EIS function is performed without the correction area provided within the image forming area 20. Therefore, the image distortion due to the camera shake can be corrected while suppressing the reduction in the angle of view. For example, the output area 12 by the cropless EIS function can be output as an area in which the number of pixels is not substantially decreased from the image forming area 20, similarly to the case where the cropping amount Eo is not provided in setting the base area 21 in the image data 10 as illustrated in FIG. 5.

In the present embodiment, the digital camera 1 further includes: the operation interface 130 (a user interface) configured to input a user operation, the user operation selecting the correction mode to be used for the image stabilization from a plurality of correction modes (image stabilization modes). The plurality of correction modes includes a “cropless” correction mode (first image stabilization mode) and a correction mode with cropping (second image stabilization mode), the “cropless” correction mode being an operation mode to perform the image stabilization without the correction area provided inside the image forming area 20 (within the range corresponding to the imaging area), the correction mode with cropping being an operation mode to perform the image stabilization is performed with the correction area, such as the correction modes of “crop high” and “crop low” (see FIG. 4). Therefore, it is possible to select the cropless correction mode by the user operation, and the cropless EIS function can be executed according to the user's selection.

In the present embodiment, in the cropless correction mode, the image stabilization is performed at a decrease ratio smaller than a decrease ratio in the correction mode with cropping to output the image of the output area 12, the decrease ratio indicating a ratio at which the number of pixels decreases by the image stabilization in each correction mode. Therefore, in the cropless correction mode, an image with higher resolution can be output compared to an image output in the correction mode with cropping.

In the present embodiment, the image corrector 143 performs the image stabilization by the cropless EIS function without the correction area by adjusting a shape of the reference area 11 according to the detected shake amount using the enlarged image area 13 in the corrected image area by the distortion correction, the correction area being set according to the cropping amount Eo of the predetermined amount and provided within the image forming area 20, the enlarged image area 13 being enlarged to outside of the image forming area 20 (an area enlarged to outside of the range corresponding to the imaging area), the reference area 11 being referred to output the image of the output area 12 (S5, S6) (see FIGS. 8 and 5). Therefore, for example, it is possible to prevent the output area 12 from being narrowed by the correction area, and the image distortion due to the camera shake can be corrected while suppressing the reduction in the angle of view. Furthermore, in the present embodiment, when a camera shake such as a tilt shake in which a posture of the digital camera 1 (imaging apparatus) changes with respect to a subject corresponding to the subject image occurs, the image corrector 143 (image processor) performs image stabilization by the cropless EIS function by adjusting a shape of the reference area 11 (area to be referred) to cancel the distortion of an image of the output area 12 due to the shake in the posture (S5, S6).

In the present embodiment, the digital camera 1 further includes a sensor driver 181 (sensor driver) and an OIS driver 221 (lens driver), the sensor driver 181 performing optical image stabilization by moving the image sensor 110 in a plane perpendicular to an optical axis of the optical system, the OIS driver 221 performing optical image stabilization by moving the OIS lens 220 (a correction lens) included in the optical system in a plane perpendicular to the optical axis. In the optical image stabilization, the image sensor 110 or both the image sensor 110 and the OIS lens are moved to cancel the detected shake amount. The image corrector 143 performs the image stabilization without moving the output area 12 for the image against a corrected shake amount in the detected shake amount, by adjusting a shape of the reference area 11 to be referred to for outputting the image of the output area 12, in the corrected image area by the distortion correction, the corrected shake amount being canceled by the optical image stabilization, the reference area 11 being referred to output the image of the output area 12 (S5, S6).

As described above, the image corrector 143 does not perform correction by the EIS function on the shake amount canceled by the optical image stabilization (i.e., IBIS and/or OIS) function. For example, in the EIS function, only the perspective correction can be performed with respect to the shake amount in the perspective distortion separately from the shake correction amount by the optical image stabilizing function. Therefore, the image distortion due to the camera shake by the tilt can be corrected while suppressing the reduction in the angle of view.

In the present embodiment, the distortion aberration of the optical system is negative at least in a peripheral part of the imaging area, and the image corrector 143 performs the distortion correction in the image area by enlarging at least an area corresponding to the peripheral part to outside of the range of the image forming area 20 corresponding to the imaging area, the image area being indicated by the image data 10 (S2, S6). Therefore, it is possible to obtain the enlarged image area 13 by the distortion correction, and to perform the cropless EIS function using the enlarged image area 13.

In the present embodiment, the digital camera 1 further includes: the body mount 150 and the lens mount 250 (each as an example of a communication interface) configured to communicate with the optical system; and the camera controller 140 (controller) configured to control the communication interface and the image corrector 143. The camera controller 140 acquires the distortion characteristic data 30 (information regarding the distortion aberration) of the optical system from the optical system via the body mount 150 and the lens mount 250, and causes the image corrector 143 to perform the image stabilization without the correction area in the corrected image area by the distortion correction when the surplus area 15 outside the range of the image forming area 20 corresponding to the imaging area is detected based on the acquired information and information indicating the imaging area, the correction area being provided within the image forming area 20 (YES in S22) (S23, S5, S6) (see FIG. 12). Therefore, in a case where the surplus area 15 is detected, in response to that the enlarged image area 13 by the distortion correction is obtained, the image distortion due to the camera shake can be corrected while suppressing the reduction in the angle of view.

### Second Embodiment

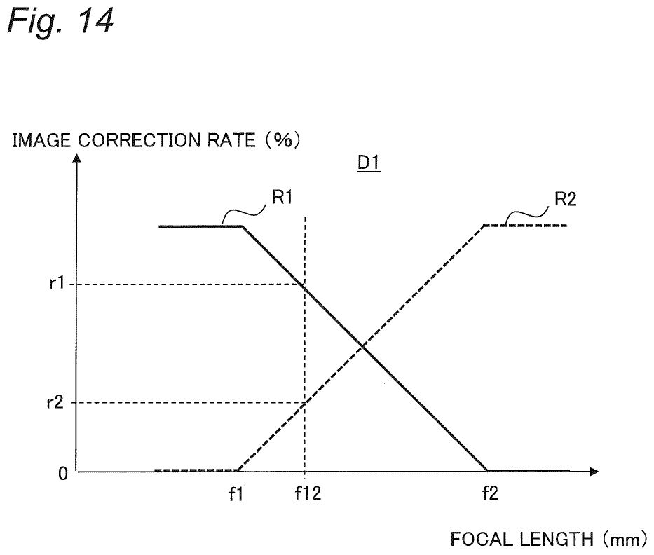

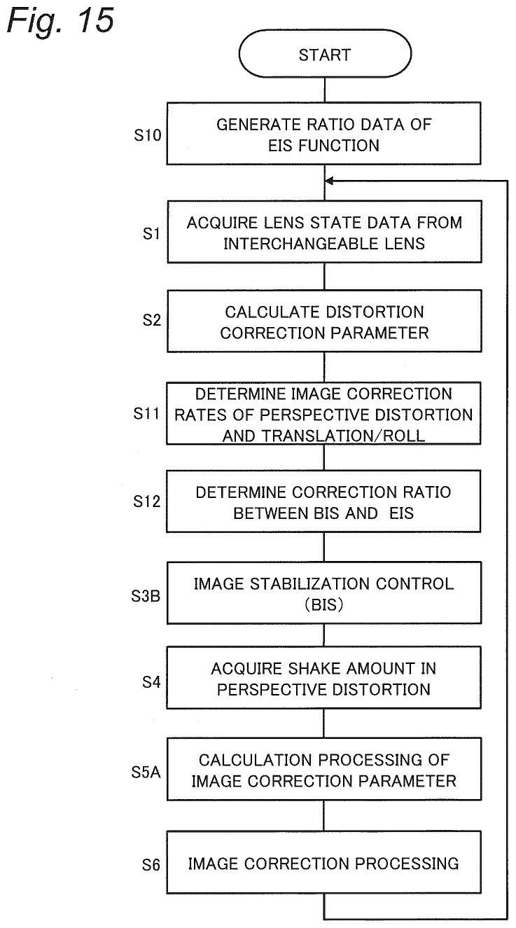

Hereinafter, a second embodiment of the present disclosure will be described with reference to FIGS. 14 to 15. In the first embodiment, the example is described in which the digital camera 1 performs, by the optical image stabilizing function such as the IBIS function, the image stabilizing operation other than the perspective correction, and performs the perspective correction by the cropless EIS function. In the second embodiment, a digital camera 1 that further performs, by the EIS function, the image stabilizing operation other than the perspective correction in the operation in the cropless correction mode will be described.

Hereinafter, the digital camera 1 according to the present embodiment will be described while descriptions of the similar configuration and operation to those of the digital camera 1 according to the first embodiment are omitted as appropriate.

### 1. Overview

In a captured image Im captured by the digital camera 1, the trapezoidal distortion due to various types of camera shakes by the tilt is likely to occur in the peripheral part of an image in wide-angle shooting, as described above, the camera shakes being caused as a change in a posture by which a line-of-sight direction viewing a subject from the digital camera 1 is inclined, for example (see FIGS. 7B to 7D). Furthermore, for example, in the wide-angle shooting in which the focal length of an interchangeable lens 200 is relatively short, such distortion of the peripheral part in the captured image Im may be increased by an increase of a correction angle corresponding to the displacement amount of an image sensor 110 by the IBIS function. On the other hand, the inventor of the present application noticed tendency that an influence of the distortion in the captured image Im is less likely to occur in telephoto shooting in which the focal length of an interchangeable lens 200 is relatively long.

The inventor of the present application intensively studied from a viewpoint of this observation, and created the digital camera 1 of the present embodiment. For example, in a case where the focal length is relatively long as described above, influence of the perspective distortion in the captured image Im due to the shake as the tilt is relatively small, and it is assumed that such distortion can be corrected, even when a part of the surplus area 15 (see FIG. 12) generated by the distortion correction is used for the perspective correction.

Therefore, the digital camera 1 of the present embodiment utilizes an area that is not used for perspective correction in the surplus area 15, for other image stabilization by the EIS function, such as translation and/or rotation of the image area 22 illustrated in FIG. 5, for example. Therefore, by efficiently using the enlarged image area 13 including the surplus area 15 obtained by the distortion correction, it is possible to perform other image stabilization by the EIS function in addition to the perspective correction while suppressing the reduction in the angle of view due to the cropping of the image.

The digital camera 1 of the present embodiment performs the image stabilizing operation by changing the ratio in the EIS function between the perspective correction and other image stabilization such as translation/rotation correction as described above, according to the focal length of the interchangeable lens 200. In the present embodiment, the digital camera 1 dynamically determines an image correction ratio by the EIS function according to the focal length in the zoom state of the interchangeable lens 200. FIG. 14 is a diagram for illustration of the operation of the digital camera 1 according to the second embodiment.

FIG. 14 illustrates ratio data D1 referred to by the digital camera 1 in the determination of the image correction ratio. In FIG. 14, the horizontal axis represents the focal length of the interchangeable lens 200, and the vertical axis represents an image correction rate in the EIS function. As illustrated in FIG. 14, for example, the ratio data D1 indicates image correction rates for each focal length. In the present embodiment, the ratio data D1 is generated such that an image correction rate R1 for the perspective correction decreases and an image correction rate R2 for the translation/rotation correction increases, as the focal length increases within a predetermined range (e.g., f1 to f2 in FIG. 14). The operation of the digital camera 1 related to the image correction rates R1 and R2 will be described below.

### 2. Operation

FIG. 15 is a flowchart illustrating an operation of the digital camera 1 according to the second embodiment. The digital camera 1 of the present embodiment performs, in addition to or instead of the processing similar to the operation in the first embodiment (FIG. 9) (S1 to S6), processing related to the translation/rotation correction added to the perspective correction by the EIS function (S10, S11 to S12, S3B, S5A). The processing of this flowchart is started when the digital camera 1 is activated, for example.

A camera controller 140 of the digital camera 1 generates the ratio data D1 as illustrated in FIG. 14 based on the distortion characteristic data 30 (see FIG. 6A) of the interchangeable lens 200, for example (S10). In step S10, the camera controller 140 acquires the distortion characteristic data 30 according to the focal length from the interchangeable lens 200 via a body mount 150 and a lens mount 250. The camera controller 140 generates the ratio data D1 by setting the image correction rates R1 and R2 based on distortion characteristics indicated by the distortion characteristic data 30 for each focal length, for example. The image correction rates R1 and R2 are set according to the focal length under a normalization condition such that the sum of R1 and R2 is “1”, for example.

For example, the image correction rates R1 and R2 at each focal length are set from a viewpoint of shake amounts in the horizontal direction and the vertical direction of the image sensor 110, and in the roll direction that can be canceled within the element drive range by the IBIS function, in addition to influence of the image distortion as the perspective distortion. In an example described below, a maximum value or a minimum value of each of the image correction rates R1 and R2 is set at focal lengths f1 and f2 of FIG. 14, assuming a situation where the camera shake is relatively large, such as where the user shoots a moving image or the like while walking, for example. From the above assumption, the image correction rates R1 and R2 of this example are set such that the correction angle is 1.4 degrees or more in the translation direction such as the horizontal direction and the vertical direction of the image sensor 110, and the correction angle is 1.0 degrees or more in the roll direction.

For example, at the focal length f1 (e.g., 20 mm), when a correction angle converted from the displacement amount of the image sensor 110 in the element drive range is 3 degrees or more, the lower limit of the correction angle in the situation of shooting the moving image while walking as described above can be covered only by the IBIS function. Therefore, in this example, regarding the focal length f1, the image correction rate R1 for the perspective correction is set to 100% as the maximum value, and the image correction rate R2 for the translation/rotation correction is set to 0% as the minimum value.

On the other hand, for example, when the correction angle within the element drive range by the IBIS function is about 1.4 degrees at the focal length f2 (e.g., 50 mm), it may be difficult to cover the lower limit of the correction angle only by the IBIS function. Furthermore, as the focal length increases as described above, the influence of the perspective distortion is less likely to appear in the peripheral part of the captured image Im. In this example, regarding the focal length f2, the image correction rate R1 for the perspective correction is set to 0%, and the image correction rate R2 for the translation/rotation correction is set to 100%.

In the range from the focal length f1 to f2, the image correction rates R1 and R2 in this example are set to linearly change within the respective setting values at each of the focal lengths f1 and f2. In this example, the camera controller 140 sets the image correction rates R1 and R2 for each focal length as rates of areas that can be used respectively for the perspective correction and the translation/rotation correction in the surplus area 15 by the cropless EIS function. The camera controller 140 generates the ratio data D1 of the EIS function by setting the image correction rates R1 and R2 as described above, for example, and stores the generated ratio data D1 in the RAM141 or the like (S10). The image correction rates R1 and R2 are not limited to the above-described linearly changing example, and may be set to change nonlinearly (e.g., in a curved manner) according to the focal lengths.

After generating the ratio data D1 of the EIS function (S10), the camera controller 140 acquires the lens state data from the interchangeable lens 200 and calculates the distortion correction parameter (S2) in parallel with the operation such as capturing a moving image, for example, similarly to the operation in the first embodiment (FIG. 9). The lens state data includes the focal length corresponding to the zoom state by the zoom lens 210 of the interchangeable lens 200.

In the present embodiment, the camera controller 140 determines the image correction rates R1 and R2 according to the focal lengths in the ratio data D1 for the perspective correction and the translation/rotation correction by the EIS function, respectively, based on the focal length of the acquired lens state data (S11).

Furthermore, the camera controller 140 performs processing of determining correction ratio between the IBIS processor 183 and the image corrector 143 for each of the horizontal direction, the vertical direction of the image sensor 110, and the roll direction, for example (S12). For example, in step S12, the camera controller 140 acquires information such as the element drive range of the IBIS function from the flash memory 142 or the like. The camera controller 140 determines the correction ratio based on the image correction rate R2 for the translation/rotation correction in addition to the acquired information and lens state data (S12). For example, according to the image correction rate R2, the cropping amount Eo by the EIS function may be set outside the range of the image forming area 20 as illustrated in FIG. 5, and the set cropping amount Eo may be used to determine the correction ratio.

The correction ratio described above includes an IBIS rate indicating an allocation to the IBIS processor 183 and an EIS rate indicating an allocation to the image corrector 143, as rates respectively set in advance for the IBIS function and EIS function to distribute each of shake correction amounts in the horizontal direction and the vertical direction of the image sensor 110, and in the roll direction. The correction ratio is determined according to an upper limit value of the shake correction amount that can be distributed to each of the IBIS function and the EIS function under such a normalization condition that the sum of the IBIS rate and the EIS rate is “1”, for example. For example, the IBIS rate and the EIS rate in the correction ratio can be determined as rates in accordance with a ratio between the respective upper limits (S12).

The camera controller 140 controls the image stabilizing operation by the IBIS function according to the IBIS rate in the determined correction ratio (S3B). The camera controller 140 sets a gain indicating the IBIS rate in the IBIS processor 183, for example. The IBIS processor 183 calculates the shake correction amount by multiplying the shake detection signal from the integrator 408 by the gain set for each execution cycle of this flowchart. The gains for the shake detection signals in the yaw direction, the pitch direction, and the roll direction may be the same or may be set separately.

Thereafter, the camera controller 140 acquires the shake amount in the perspective distortion from the IBIS processor 183, for example, similarly to the example of FIG. 9 (S4).

The camera controller 140 calculates a perspective correction parameter and a parameter used for the translation/rotation correction by the EIS function as image correction parameters based on the image correction rates R1 and R2 determined in step S12, for example (S5A).

For example, the camera controller 140 calculates the perspective correction parameter limited to a value at which the image can be deformed within the range of the image correction rate R1 in the surplus area 15, from parameters of the projective transformation calculated based on the shake amount in the perspective distortion and the like similarly to step S5 in FIG. 9 (S5A). Furthermore, the camera controller 140 calculates the parameter for the translation/rotation correction limited to a value at which the image area 22 can be moved within a range of the image correction rate R2 in the surplus area 15, from the gain indicating the EIS rate of the correction ratio determined in step S12, for example (S5A). For example, the gain calculated according to the EIS rate as the parameter for the translation/rotation correction is multiplied by the shake detection signal input from the integrator 408 of the IBIS processor 183 in the image corrector 143.

The camera controller 140 executes arithmetic processing as the image corrector 143 based on the distortion correction parameter calculated in step S2 and the image correction parameter calculated in step S5A instead of the perspective correction parameter of the first embodiment (S6). In step S6 of the present embodiment, for example, in addition to processing to deform an image as the distortion correction and the perspective correction, processing to move the image area 22 by at least one of translational movement and rotational movement is performed as the translation/rotation correction. After executing such image correction processing (S6), the camera controller 140 ends the processing of this flowchart.

According to the above processing, the ratio data D1 including the image correction rates R1 and R2 for each focal length in the EIS function is generated from the distortion characteristic data 30 according to the focal length of the interchangeable lens 200, for example (S10). Based on the ratio data D1 and the focal length in the lens state data of the interchangeable lens 200, the image correction rate R1 for the perspective correction and the image correction rate R2 for the translation/rotation correction in the EIS function are determined (S11). For example, for the horizontal direction and the vertical direction of the image sensor 110, and for the roll direction, the correction ratio between the IBIS processor 183 and the image corrector 143 is determined according to the image correction rate R2 and the like (S12).

Furthermore, the image stabilization control by the IBIS function is performed according to the IBIS rate in the determined correction ratio (S3B), and the shake amount in the perspective distortion is acquired (S4). Then, the perspective correction parameter and the parameter of the translation/rotation correction are calculated based on the image correction rates R1 and R2 in addition to the shake amount in the perspective distortion (S5A), and the image correction processing according to the image correction parameter and the distortion correction parameter is executed (S6). In this manner, for example, in the surplus area 15 generated by the distortion correction, the perspective correction and the translation/rotation correction by the EIS function can be performed according to the image correction rates R1 and R2, respectively.

For example, at a focal length f12 illustrated in FIG. 14, the shake amount in the perspective distortion can be canceled, according to the ratio data D1 reflecting the distortion characteristics of the interchangeable lens 200, even when the perspective correction using the surplus area 15 generated by the distortion correction is performed within a range of an image correction rate r1 in the EIS function. On the other hand, at the focal length f12, in a case where the surplus area 15 not used for the perspective correction remains, the surplus area 15 and the like due to the distortion correction can be efficiently used by performing the translation/rotation correction within a range of an image correction rate r2 in the EIS function. As described above, for example, the perspective correction and the like can be efficiently performed by the cropless EIS function while suppressing the reduction in the angle of view.

The example in which the ratio data D1 of the EIS function is generated to include the image correction rates R1 and R2 is described above (S10). The ratio data D1 may include only one of the image correction rates R1 and R2, and the other may be calculated as needed from the relationship of change of the two rates R1 and R2 according to the focal lengths, for example. Further, the ratio data D1 may be generated in advance before performing the processing of this flowchart and stored in the flash memory 142 or the like, for example.

In the above description, the example is described in which the image stabilization control by the IBIS function (S3B) and the image correction processing (S6) are performed at the IBIS rate and the EIS rate in the correction ratio determined in step S12. The correction by the IBIS processor 183 and the image corrector 143 is not limited to the above example. For example, when a correction amount remains even after the translation/rotation correction is performed by the EIS function in the image correction processing (S6), the image stabilization according to the element drive range or the like may be performed by the IBIS function for the remaining correction amount.

The example in which the perspective correction and the translation/rotation correction are performed according to the image correction rates R1 and R2 in the EIS function is described above. In the EIS function, as the image stabilizing operation other than the perspective correction according to such an image correction ratio, the image stabilizing operation by image processing different from the translation/rotation correction may be performed.

In the above description, the example is described in which the processing of this flowchart is started when the digital camera 1 is activated. This processing may be started, for example, when the interchangeable lens 200 is attached to the camera body 100.

### 3. Summary

As described above, the digital camera 1 (an example of an imaging apparatus) according to the present embodiment includes: the image sensor 110 (an example of an image sensor) configured to capture a subject image to generate image data, the image sensor having an imaging area in which the subject image is formed through the optical system; the gyro sensor 184, 224 (each as an example of a sensor) configured to detect a shake amount of the digital camera 1; the image corrector 143 (an example of an image processor) configured to perform image stabilization by adjusting an output area according to the shake amount detected by the sensor, the output area being output as an image in the image data; and the camera controller 140 (an example of a controller) that controls image stabilization performed by the image corrector 143. In the image corrector 143, distortion correction responsive to the distortion aberration of the optical system is performed on an image area indicated by the image data. The camera controller 140 changes the image correction rates R1 and R2 indicating a ratio between the perspective correction and the translation/rotation correction (examples of the first image stabilization and the second image stabilization, respectively) according to a focal length of the optical system, the perspective correction and the translation/rotation correction being performed by the image corrector 143 in the EIS function, for example, on a corrected image by the distortion correction (S11). The perspective correction corrects the perspective distortion of the image in the corrected image by the distortion correction (see FIG. 8). The translation/rotation correction moves the output area for the image in the image area (see FIG. 5).

According to the digital camera 1 described above, for example, according to a focal length of the optical system in the interchangeable lens 200, the ratio between the perspective correction and the translation/rotation correction performed in the image area to which the distortion correction has been performed, such as the surplus area 15, by the EIS function is changed. Therefore, the image distortion due to the camera shake can be efficiently corrected while suppressing the reduction in the angle of view. For example, in the cropless EIS mode, by changing the ratio between the perspective correction and the translation/rotation correction in the EIS function according to the focal lengths which changes the influence of the image distortion due to the camera shake by the tilt, the surplus area 15 generated by the distortion correction can be efficiently used.

In the present embodiment, the optical system includes the zoom lens 210 of the interchangeable lens 200 (see FIG. 2). The camera controller 140 changes the image correction rates R1 and R2 (an example of the ratio between the perspective correction and the translation/rotation correction) when the focal length is changed by the zoom lens 210 (see S11, FIG. 14). Therefore, for example, the image correction rates R1 and R2 can be changed according to the zoom state by the zoom lens 210.

In the present embodiment, the camera controller 140 changes the image correction rates R1 and R2 such that the image correction rate R2 (an example of a proportion of the second image stabilization in the ratio between the first image stabilization and the second image stabilization) increases as the focal length increases in a predetermined range (see S11, FIG. 14). Therefore, for example, it is possible to efficiently perform the perspective correction and the translation/rotation correction by the EIS function in the surplus area 15, according a tendency that the influence of the image distortion due to the camera shake by the tilt is less likely to occur while the upper limit of the correction angle by the IBIS function decreases as the focal length increases.

In the present embodiment, the camera controller 140 causes the image corrector 143 to perform the perspective correction to correct the perspective distortion of the image due to a change in a posture of the digital camera 1 in the detected shake amount, the change inclining a line-of-sight direction viewing the subject from the digital camera 1 (S4 to S6). Therefore, it is possible to correct, by the perspective correction, the image distortion of due to the camera shake in image shooting.

In the present embodiment, the image corrector 143 performs the perspective correction by the cropless EIS function without a correction area provided within the image forming area 20 (a range corresponding to the imaging area), in the corrected image area by the distortion correction, to crop the image of the output area such as the image area 22 (S5A, S6) (see FIGS. 5 and 8). Therefore, the image distortion due to the tilt shake can be corrected while suppressing the reduction in the angle of view.

In the present embodiment, the digital camera 1 further includes the sensor driver 181 (a sensor driver) and the OIS driver 221 (a lens driver), the sensor driver performing optical image stabilization by moving the image sensor 110 in a plane perpendicular to an optical axis of the optical system, the OIS driver performing optical image stabilization by moving the OIS lens 220 (a correction lens) included in the optical system in a plane perpendicular to the optical axis. In the present embodiment, in the optical image stabilization, the image sensor 110 is moved to cancel the detected shake amount (S3B). The image corrector 143 performs the translation/rotation correction by the EIS function by moving the image area 22 (an example of the output area for the image) according to the detected shake amount, in the corrected image area by the distortion correction (S5A, S6). Therefore, similarly to the translation/rotation correction by the EIS function, correction in the translation direction and the roll direction of the image sensor 110 can be performed by the IBIS function by the sensor driver 181, for example. In addition, only one of the correction in the translation direction and the correction in the rotation direction may be performed by the EIS function, and the other correction may be performed by the IBIS function, for example.

### Other Embodiments

As described above, the first embodiment is described as an example of the technique disclosed in the present application. However, the technique in the present disclosure is not limited thereto, and can also be applied to embodiments in which changes, substitutions, additions, omissions, and the like are made as appropriate. In addition, it is also possible to combine the components described in the first embodiment to provide a new embodiment. Therefore, other embodiments will be exemplified below.

In the first embodiment described above, the example is described in which the digital camera 1 displays the cropless correction mode in a selectable manner without depending on the interchangeable lens 200 when selecting various correction modes by the EIS function on the menu screen illustrated in FIG. 4, for example. In the present embodiment, the cropless correction mode in the digital camera 1 may be enabled or disabled according to the mounted interchangeable lens 200. For example, the cropless correction mode may be displayed in a selectable manner, in a case where the camera controller 140 acquires, from the interchangeable lens 200, information indicating the type and/or lens characteristics of the interchangeable lens 200, and determines that the enlarged image area 13 by distortion correction can be obtained.

In the above embodiment, the example is described in which, when selecting various correction modes by the EIS function, selectability of the cropless correction mode is switched based on the information acquired from the interchangeable lens 200. In the present embodiment, for example, in a case where the information indicating lens characteristics such as distortion aberration cannot be acquired from the interchangeable lens 200, the EIS function in the cropless correction mode may not need to be executed even when the cropless correction mode is selected, or the cropless correction mode may be made unselectable.

In addition, the disclosure invention is not limited to the above example, and, for example, validity and invalidity of the cropless EIS function or selectability of the cropless correction mode may be managed for each interchangeable lens 200 using information indicating availability of the cropless EIS function. Such information may be stored in the flash memory 142 or the like of the camera body 100, or may be acquired from the interchangeable lens 200. For example, the availability may be set according to the limitation of a peripheral light amount of the interchangeable lens 200. Furthermore, the digital camera 1 may be configured such that when the cropless EIS function is enabled, the function of correcting the peripheral light amount may also be enabled. Furthermore, for example, in a case where an amount of decrease in the peripheral light amount due to peripheral light reduction of the optical system exceeds a predetermined allowable value, the element drive range of the IBIS function may be limited.

In the second embodiment described above, the example is described in which the digital camera 1 changes the image correction rates R1 and R2 for the perspective correction and the translation/rotation correction in the EIS function according to the focal length of the interchangeable lens 200. In the present embodiment, for example, the correction by the EIS function may be performed on a part of the shake amount that is not canceled by the IBIS function. The camera controller 140 may acquire, from the IBIS processor 183, such remaining correction amount in the IBIS function among each of the shake amounts in the yaw direction and the pitch direction, and correct the remaining correction amount by the EIS function with cropping, for example. In the present embodiment, for example, the cropless EIS function may be executed in a case where the reduction rate of the number of pixels of the image output for recording and/or display after the perspective correction from the number before the correction is 1/10 of or less than the reduction rate in the “crop low” correction mode.

In the second embodiment described above, the example is described in which the translation/rotation correction by the EIS function is performed in the cropless correction mode. The translation/rotation correction by the EIS function may be performed in the correction mode with cropping, and may be performed, for example, in the enlarged image area 13 in addition to the surplus area 15 due to distortion correction.

In the present embodiment, for example, in a case where the cropless the EIS function and the EIS function with cropping are used together, the image area 22 output by the EIS function with cropping does not need to be moved for the shake amount canceled by the optical image stabilizing function such as the IBIS function. This also makes it possible to correct image distortion due to the camera shake while suppressing the reduction in the angle of view due to the EIS function with cropping, for example. Further, in the EIS function with cropping, the enlarged image area 13 enlarged by the distortion correction can be used for cropping the image area 22.

In the above embodiment, the example is described in which the shake amounts in the yaw direction, the pitch direction, and the roll direction are corrected by the EIS function with cropping in addition to the perspective correction by the cropless EIS function. In the present embodiment, for example, image distortion due to a rolling shutter phenomenon may be corrected by the EIS function. For example, such correction may be performed using a plurality of projective transformation matrices corresponding to such distortion characteristics as correction parameters.

In the second embodiment described above, the example is described in which the image stabilization control (S3B) by the IBIS function and the image correction processing (S6) by the EIS function are performed according to the correction ratio determined between the IBIS processor 183 and the image corrector 143 (S11). In the present embodiment, for example, the image stabilization may be further performed by the OIS processor 223 for the shake amount in the translation direction of the image sensor 110. For example, the IBIS rate in step S11 in FIG. 15 may be further distributed to a correction ratio between the IBIS processor 183 and the OIS processor 223 similar to the shake correction parameter (S30 in FIG. 13) in the modified example of the first embodiment. In the present embodiment, in the optical image stabilization, at least one of the image sensor 110 and the OIS lens 220 is moved to cancel the detected shake amount.

In the second embodiment described above, the example is described in which the interchangeable lens 200 includes the zoom lens 210. In the present embodiment, for example, for an interchangeable lens such as a single focal length lens not including a zoom lens, the perspective correction and the translation/rotation correction in the image correction rates R1 and R2 may be performed according to the focal length of the interchangeable lens in the EIS function similarly to the second embodiment. In the present embodiment, for example, only the image correction rates R1 and R2 for the focal length of the interchangeable lens may be calculated, and the ratio data D1 of the EIS function may not be generated.

In the above embodiments, the example is described in which the digital camera 1 performs, by only the IBIS function or both the IBIS function and the OIS function, the image stabilization different from the perspective correction by the cropless EIS function. In the present embodiment, for example, the image stabilizing operation different from the perspective correction may be performed only by the OIS function. As described above, the digital camera 1 of the present embodiment performs the image stabilizing operation using the shake correction amount different from the shake correction amount in the perspective correction by at least one of the OIS function and the IBIS function. The digital camera 1 of the present embodiment is not limited to the example of FIG. 1, and may have only one of the IBIS function and the OIS function.

That is, in the present embodiment, the digital camera 1 may further include at least one of the sensor driver 181 (a sensor driver) and the OIS driver 221 (a lens driver), the sensor driver performing optical image stabilization by moving the image sensor 110 in a plane perpendicular to an optical axis of the optical system, the OIS driver performing optical image stabilization by moving the OIS lens 220 (a correction lens) included in the optical system in a plane perpendicular to the optical axis. In the present embodiment, in the optical image stabilization, at least one of the image sensor 110 and the OIS lens may be moved to cancel the detected shake amount.

In the above embodiments, the example is described in which the center position Pc of the entire image in the image data 10 is used as the distortion correction center in the calculation of the distortion correction parameter (S2). In the present embodiment, for example, a position obtained by shifting the center position Pc in the image data 10 according to the shake correction amount by the optical image stabilizing function may be used as the distortion correction center. Therefore, for example, even in a case where the center position Pc deviates from an intersection point of the optical axis and the imaging plane of the image sensor 110 due to the optical image stabilizing function, the enlarged image area 13 enlarged by distortion correction may be obtained according to the lens characteristics of the interchangeable lens 200.

In the above embodiments, the example is described in which the digital camera 1 executes the cropless EIS function when capturing a moving image according to the selected correction mode of the EIS function. The digital camera of the present embodiments may execute the cropless EIS function in capturing a still image.

The above embodiments describe the digital camera of an interchangeable lens type as an example of the imaging apparatus, but the imaging apparatus of the present embodiment may be a digital camera that is not of an interchangeable lens type particularly. Furthermore, the idea of the present disclosure can be applied not only to a digital camera but also to a movie camera or an electronic device having various imaging functions such as a camera-equipped mobile phone, a smartphone, or a PC.

As described above, the embodiments are described as the examples of the technique in the present disclosure. For this purpose, the accompanying drawings and the detailed description are provided.

Therefore, the components described in the accompanying drawings and the detailed description may include not only components essential for solving the problem but also components that are non-essential for solving the problem in order to illustrate the above technique. Therefore, it should not be immediately recognized that these non-essential components are essential based on that these non-essential components are described in the accompanying drawings and the detailed description.

In addition, since the above-described embodiments are intended to illustrate the technique in the present disclosure, various changes, substitutions, additions, omissions, and the like can be made within the scope of the claims or equivalents thereof.

### Aspect Examples

Hereinafter, various aspects of the present disclosure will be exemplified.

A first aspect according to the present disclosure is an imaging apparatus including: an image sensor configured to capture a subject image to generate image data, the image sensor having an imaging area in which the subject image is formed through an optical system; a sensor configured to detect a shake amount of the imaging apparatus; and an image processor configured to perform image stabilization by adjusting an output area according to the shake amount detected by the sensor, the output area being output as an image in the image data. In the image processor, distortion correction responsive to distortion aberration of the optical system is performed on an image area indicated by the image data. The image processor performs the image stabilization without a correction area in a corrected image area by the distortion correction, the correction area being provided within a range corresponding to the imaging area to crop the image of the output area.

A second aspect is the imaging apparatus according to the first aspect, further including a user interface configured to input a user operation, the user operation selecting an image stabilization mode to be used for the image stabilization from a plurality of image stabilization modes. The plurality of image stabilization modes includes a first image stabilization mode and a second image stabilization mode, the first image stabilization mode being an operation mode to perform the image stabilization without the correction area provided within the range corresponding to the imaging area, the second image stabilization mode being an operation mode to perform the image stabilization with the correction area.

A third aspect is the imaging apparatus according to the second aspect, wherein in the first image stabilization mode, the image stabilization is performed at a decrease ratio smaller than a decrease ratio in the second image stabilization mode to output the image of the output area, the decrease ratio indicating a ratio at which the number of pixels decreases by the image stabilization in each image stabilization mode.

A fourth aspect is the imaging apparatus according to any one of the first to third aspects, wherein the image processor performs the image stabilization without the correction area by adjusting a shape of a reference area according to the detected shake amount using an enlarged area in the corrected image area by the distortion correction, the correction area being provided within the range corresponding to the imaging area, the reference area being referred to output the image of the output area, the enlarged area being enlarged to outside of the range corresponding to the imaging area.

A fifth aspect is the imaging apparatus according to any one of the first to fourth aspects, further including at least one of a sensor driver or a lens driver, the sensor driver being configured to perform optical image stabilization by moving the image sensor in a plane perpendicular to an optical axis of the optical system, the lens driver being configured to perform optical image stabilization by moving a correction lens included in the optical system in a plane perpendicular to the optical axis. In the optical image stabilization, at least one of the image sensor or the lens driver is moved to cancel the detected shake amount. The image processor performs the image stabilization without moving the output area for the image against a corrected shake amount in the detected shake amount, by adjusting a shape of a reference area in the corrected image area by the distortion correction, the corrected shake amount being canceled by the optical image stabilization, the reference area being referred to output the image of the output area.

A sixth aspect is the imaging apparatus according to any one of the first to fifth aspects, wherein the distortion aberration of the optical system is negative at least in a peripheral part of the imaging area. The image processor performs the distortion correction in the image area by enlarging at least an area corresponding to the peripheral part to outside of the range corresponding to the imaging area, the image area being indicated by the image data.

A seventh aspect is the imaging apparatus according to any one of the first to sixth aspects, further including a communication interface configured to communicate with the optical system; a controller configured to control the communication interface and the image processor. The controller is configured to: acquire information on the distortion aberration of the optical system from the optical system via the communication interface, and cause the image processor to perform the image stabilization without the correction area in the corrected image area by the distortion correction when an area outside the range corresponding to the imaging area is detected based on the acquired information and information indicating the imaging area, the correction area being provided within the range corresponding to the imaging area.

A eighth aspect according to the present disclosure is an imaging apparatus including: an image sensor configured to capture a subject image to generate image data, the image sensor having an imaging area in which the subject image is formed through an optical system; a sensor configured to detect a shake amount of the imaging apparatus; an image processor configured to perform image stabilization by adjusting an output area according to the shake amount detected by the sensor, the output area being output as an image in the image data; and a controller configured to control the image stabilization performed by the image processor. In the image processor, distortion correction responsive to distortion aberration of the optical system is performed on an image area indicated by the image data. The controller changes a ratio between first image stabilization and second image stabilization according to a focal length of the optical system, the first and second image stabilizations each being performed by the image processor in a corrected image area by the distortion correction. The first image stabilization corrects perspective distortion of the image in the corrected image area by the distortion correction. The second image stabilization moves the output area for the image in the image area.

The movement of the output area in the second image stabilization includes translational movement and rotational movement. The movement in the second image stabilization may be either the translational movement and rotational movement.

A ninth aspect is the imaging apparatus according to the eighth aspect, wherein the optical system includes a zoom lens, and the controller changes the ratio between the first image stabilization and the second image stabilization when the focal length is changed by the zoom lens.

A tenth aspect is the imaging apparatus according to the eighth or ninth aspect, wherein the controller changes the ratio such that a proportion of the second image stabilization in the ratio between the first image stabilization and the second image stabilization increases as the focal length increases in a predetermined range.

A eleventh aspect is the imaging apparatus according to any one of the eighth to tenth aspects, wherein the controller causes the image processor to perform the first image stabilization to correct the perspective distortion of the image due to a change in a posture of the imaging apparatus in the detected shake amount, the change inclining a line-of-sight direction viewing a subject from the imaging apparatus.

A twelfth aspect is the imaging apparatus according to any one of the eighth to eleventh aspects, wherein the image processor performs, in the corrected image area by the distortion correction, the first image stabilization without a correction area provided within a range corresponding to the imaging area to crop the image of the output area.

A thirteenth aspect is the imaging apparatus according to the twelfth aspect, wherein the image processor performs the first image stabilization without the correction area in the corrected image area by the distortion correction by adjusting a shape of a reference area according to the detected shake amount using an area enlarged to outside of the range corresponding to the imaging area, the correction area being provided within the range corresponding to the imaging area, the reference area being referred to output the image of the output area.

A fourteenth aspect is the imaging apparatus according to any one of the eighth to thirteenth aspects, further including at least one of a sensor driver or a lens driver, the sensor driver being configured to perform optical image stabilization by moving the image sensor in a plane perpendicular to an optical axis of the optical system, the lens driver being configured to perform optical image stabilization by moving a correction lens included in the optical system in a plane perpendicular to the optical axis. In the optical image stabilization, at least one of the image sensor or the lens driver is moved to cancel the detected shake amount. The image processor performs the second image stabilization to move the output area for the image according to the detected shake amount, in the corrected image area by the distortion correction.

A fifteenth aspect is the imaging apparatus according to any one of the eighth to fourteenth aspects, wherein the distortion aberration of the optical system is negative at least in a peripheral part of the imaging area. The image processor performs the distortion correction in the image area by enlarging at least an area corresponding to the peripheral part to outside of a range corresponding to the imaging area, the image area being indicated by the image data.

The concept of the present disclosure can be applied to an electronic device (e.g., imaging apparatuses such as digital cameras, camcorders, mobile phones, smartphones, and the like) having an image shooting function provided with an image stabilizing function.

1. An imaging apparatus comprising:
an image sensor configured to capture a subject image to generate image data, the image sensor having an imaging area in which the subject image is formed through an optical system;
a sensor configured to detect a shake amount of the imaging apparatus; and
an image processor configured to perform image stabilization by adjusting an output area according to the shake amount detected by the sensor, the output area being output as an image in the image data, wherein
in the image processor, distortion correction responsive to distortion aberration of the optical system is performed on an image area indicated by the image data, and
the image processor performs the image stabilization without a correction area in a corrected image area by the distortion correction, the correction area being provided within a range corresponding to the imaging area to crop the image of the output area.

2. The imaging apparatus according to claim 1, further comprising
a user interface configured to input a user operation, the user operation selecting an image stabilization mode to be used for the image stabilization from a plurality of image stabilization modes, wherein
the plurality of image stabilization modes includes a first image stabilization mode and a second image stabilization mode, the first image stabilization mode being an operation mode to perform the image stabilization without the correction area provided within the range corresponding to the imaging area, the second image stabilization mode being an operation mode to perform the image stabilization with the correction area.

3. The imaging apparatus according to claim 2, wherein
in the first image stabilization mode, the image stabilization is performed at a decrease ratio smaller than a decrease ratio in the second image stabilization mode to output the image of the output area, the decrease ratio indicating a ratio at which the number of pixels decreases by the image stabilization in each image stabilization mode.

4. The imaging apparatus according to claim 1, wherein
the image processor performs the image stabilization without the correction area by adjusting a shape of a reference area according to the detected shake amount using an enlarged area in the corrected image area by the distortion correction, the correction area being provided within the range corresponding to the imaging area, the reference area being referred to output the image of the output area, the enlarged area being enlarged to outside of the range corresponding to the imaging area.

5. The imaging apparatus according to claim 1, further comprising
at least one of a sensor driver or a lens driver, the sensor driver being configured to perform optical image stabilization by moving the image sensor in a plane perpendicular to an optical axis of the optical system, the lens driver being configured to perform optical image stabilization by moving a correction lens included in the optical system in a plane perpendicular to the optical axis, wherein
in the optical image stabilization, at least one of the image sensor or the lens driver is moved to cancel the detected shake amount, and
the image processor performs the image stabilization without moving the output area for the image against a corrected shake amount in the detected shake amount, by adjusting a shape of a reference area in the corrected image area by the distortion correction, the corrected shake amount being canceled by the optical image stabilization, the reference area being referred to output the image of the output area.

6. The imaging apparatus according to claim 1, wherein
the distortion aberration of the optical system is negative at least in a peripheral part of the imaging area, and
the image processor performs the distortion correction in the image area by enlarging at least an area corresponding to the peripheral part to outside of the range corresponding to the imaging area, the image area being indicated by the image data.

7. The imaging apparatus according to claim 1, further comprising:
a communication interface configured to communicate with the optical system; and
a controller configured to control the communication interface and the image processor, wherein
the controller is configured to:
acquire information on the distortion aberration of the optical system from the optical system via the communication interface, and
cause the image processor to perform the image stabilization without the correction area in the corrected image area by the distortion correction when an area outside the range corresponding to the imaging area is detected based on the acquired information and information indicating the imaging area, the correction area being provided within the range corresponding to the imaging area.

8. An imaging apparatus comprising:
an image sensor configured to capture a subject image to generate image data, the image sensor having an imaging area in which the subject image is formed through an optical system;
a sensor configured to detect a shake amount of the imaging apparatus;
an image processor configured to perform image stabilization by adjusting an output area according to the shake amount detected by the sensor, the output area being output as an image in the image data; and
a controller configured to control the image stabilization performed by the image processor, wherein
in the image processor, distortion correction responsive to distortion aberration of the optical system is performed on an image area indicated by the image data,
the controller changes a ratio between first image stabilization and second image stabilization according to a focal length of the optical system, the first and second image stabilizations each being performed by the image processor in a corrected image area by the distortion correction,
the first image stabilization corrects perspective distortion of the image in the corrected image area by the distortion correction, and
the second image stabilization moves the output area for the image in the image area.

9. The imaging apparatus according to claim 8, wherein
the optical system includes a zoom lens, and
the controller changes the ratio between the first image stabilization and the second image stabilization when the focal length is changed by the zoom lens.

10. The imaging apparatus according to claim 8, wherein
the controller changes the ratio such that a proportion of the second image stabilization in the ratio between the first image stabilization and the second image stabilization increases as the focal length increases in a predetermined range.

11. The imaging apparatus according to claim 8, wherein
the controller causes the image processor to perform the first image stabilization to correct the perspective distortion of the image due to a change in a posture of the imaging apparatus in the detected shake amount, the change inclining a line-of-sight direction viewing a subject from the imaging apparatus.

12. The imaging apparatus according to claim 8, wherein
the image processor performs, in the corrected image area by the distortion correction, the first image stabilization without a correction area provided within a range corresponding to the imaging area to crop the image of the output area.

13. The imaging apparatus according to claim 12, wherein
the image processor performs the first image stabilization without the correction area in the corrected image area by the distortion correction by adjusting a shape of a reference area according to the detected shake amount using an area enlarged to outside of the range corresponding to the imaging area, the correction area being provided within the range corresponding to the imaging area, the reference area being referred to output the image of the output area.

14. The imaging apparatus according to claim 8, further comprising
at least one of a sensor driver or a lens driver, the sensor driver being configured to perform optical image stabilization by moving the image sensor in a plane perpendicular to an optical axis of the optical system, the lens driver being configured to perform optical image stabilization by moving a correction lens included in the optical system in a plane perpendicular to the optical axis, wherein
in the optical image stabilization, at least one of the image sensor or the lens driver is moved to cancel the detected shake amount, and
the image processor performs the second image stabilization to move the output area for the image according to the detected shake amount, in the corrected image area by the distortion correction.

15. The imaging apparatus according to claim 8, wherein
the distortion aberration of the optical system is negative at least in a peripheral part of the imaging area, and
the image processor performs the distortion correction in the image area by enlarging at least an area corresponding to the peripheral part to outside of a range corresponding to the imaging area, the image area being indicated by the image data.
